(19) United States
(12) Patent Application Publication
(10) Pub. No.: US 2016/0320780 A1
(43) Pub. Date: Nov. 3, 2016

(54) METHOD AND DEVICE FOR MONITORING INDUCED PROPERTIES OF A MIXTURE OF COMPONENTS, IN PARTICULAR EMISSION PROPERTIES

(71) Applicant: TOTAL RAFFINAGE CHIMIE, Courbevoie (FR)

(72) Inventors: Mériam CHEBRE, Septeme (FR); Guillaume PITOLLAT, Lyon (FR); Stefan JANAQI, Jacou (FR)

(21) Appl. No.: 15/108,451

(22) PCT Filed: Dec. 26, 2014
(86) PCT No.: PCT/EP2014/079349

§ 371 Date: Jun. 27, 2016

(30) Foreign Application Priority Data
Dec. 26, 2013 (FR) 1363597

(51) Int. Cl. G05D 11/13; G06F 17/10

(52) U.S. Cl. CPC G05D 11/139; G06F 17/10

(57) ABSTRACT

A method for monitoring properties of a mixture M of n components is provided. The mixture has properties x(B, u), where u is a recipe vector, B is a matrix of the properties of the n components, and x(u) is a vector of the k properties of the mixture M. The mixture also has at least one emission property representative of a product emitted by the mixture during the use thereof. The method includes monitoring the recipe u such that the resulting mixture M complies with specifications for each emission property. The monitoring includes estimating an emission property of mixture M of properties determined beforehand.

### TECHNICAL FIELD

The invention relates to a method and a device for monitoring the induced properties of a mixture of constituents.

Such so-called “induced” properties result from the properties of the mixture and might not be directly measurable. These induced properties relate for example to emissions produced during the use of said mixture.

It applies more particularly to the automatic regulation of mixtures of constituents on-line, such as for example mixtures of petroleum products, in which the mixtures produced must conform to a set of significant specifications or properties. In these applications, each product contained in the mixture acts on a subset or on the set of properties of the final mixture obtained.

### PRIOR ART

For environmental reasons, certain of the imposed specifications are related to the products emitted by the mixture during its use and are aimed at reducing these emissions. In the case of mixtures of petroleum products, these emissions are emitted during combustion of the mixture in an engine. Specifications of this type thus make it possible to reduce emissions, in particular those of engined vehicles.

For example, the American Environmental Protection Agency (EPA) imposes particular specifications in order to reduce vehicle emissions (nitrogen oxide NOₓ, volatile organic compounds VOCs and toxic organic compounds TOXs). In this effort, the EPA has developed empirical models for predicting the emissions from a gasoline as a function of its properties with respect to a reference gasoline. All American refiners and refiners that export to the United States calculate and certify the emissions of reformulated gasolines that they produce with this model, known by the name “Complex Emissions Model”. This complex model is detailed in document e-CFR §80.45 of the Electronic Code of Federal Regulations (e-CFR) of the American government; it will be referred to by the name 80.45EPACM hereinafter in the patent application. 80.45EPACM uses certain properties of the mixture (oxygen content, sulfur content, vapor pressure, etc.) as input variables.

80.45EPACM also makes provision for procedures for calculating output data which are the emissions of noxious or undesirable compounds, namely the emissions of volatile organic compounds (VOs), the emissions of nitrogen oxides (NOₓ) and the emissions of toxic compounds (TOXs), such as benzene, acetaldehyde, formaldehyde, 1,3-butadiene, etc.

Although it is recognized that integration of the complex model into the operational models of the manufacture of mixtures would make it possible to reduce the cost of manufacture of these mixtures, 80.45EPACM is particularly difficult to implement within operational models in the refinery or to combine with existing models for predicting the quality of the mixtures produced. This difficulty results from the complexity of the model, which provides for different specifications according to season, region and type of gasoline, imposes specifications on numerous variables and uses relatively complex NOₓ, VOC and TOX emissions calculation functions to estimate the emissions of a gasoline, these functions being nonlinear, non-convex and non-differentiable. In particular, 80.45EPACM provides a whole list of conditions (subsequently called the IF-list) which impose disjunctive constraints on the input variables of the NOₓ, VOC and TOX emissions calculation functions. The integration of this IF-list into the operational models is particularly complex and involves the use of a large number of binary and continuous variables. This results in very complex models whose calculation time is too long, of the order of several minutes, to allow their use for on-line and real-time monitoring of the properties of the mixture. Indeed, such on-line monitoring requires a periodic recipe update of the order of a minute, or indeed of the order of a few seconds, which update requires several tens of calls and is therefore not compatible with calculation times of several minutes. It is also possible to undertake manual integrations of the constraints on the input variables in the operational models, but this is also inapplicable to real-time on-line monitoring on account of the lengthy time of these inputting operations. Attempts have been made to simplify 80.45EPACM, but they lead to inaccurate approximations, too far from the results of the complex model.

### SUMMARY OF THE INVENTION

A need therefore exists for a procedure making it possible to integrate a model comprising constraints on the emissions, in particular the 80.45EPACM complex model established by the EPA, into on-line and real-time mixture optimization methods.

For this purpose, there is proposed a method for monitoring the properties of a mixture M of n constituents, said mixture exhibiting:
properties denoted either x(u) or x(B, u), where
x(u)=[x₁, . . . xₖ] is a vector of k properties of the mixture M, k a positive non-zero integer,
u=[u₁, . . . uₙ] is a recipe vector and i=1, . . . n, indicates the proportion of the ith constituent in the mixture M,
B=[B₁, . . . , Bₙ] is a matrix of the properties of the n constituents Bᵢ,
at least one property R(u)=R(y(x(u)), z(x(u))) induced by the properties x(B, u), where

z(x(u))=y(x(u))−x(u)
y(x(u)) is a vector of properties of the mixture
   and where y(x(u)) and z(x(u)) are such that they comply with disjunctive conditions which, for each property xₖ, allocate to yₖ=y(xₖ) at least one value chosen from among xₖ, mₖ, Mₖ, as a function of one or more inequalities between said value xₖ and at least one value mₖ, Mₖ, where mₖ, Mₖ are predefined constants and xₖ is the value of the property k for a recipe u.

The properties x(u) are thus properties of the mixture which are directly measurable (but which may nonetheless be determined by estimations), in contradistinction to the induced properties which are not measurable by measurements of the mixture.

The vector y(x(u)) is thus a function of the properties x(u). It thus corresponds to modified properties of the mixture M. It is for example a vector of the target properties of the mixture, these target properties being predetermined and complying with the disjunctive conditions. In particular, the target properties can correspond to the properties of a target mixture of the same nature as the mixture M.

The method according to the invention monitors said recipe u so that said mixture M obtained complies with specifications Rⱼ(u)≦R̅ⱼ̅ and/or Rⱼ≦Rⱼ(u) for each induced property Rⱼ, j=1, . . . , q (with q a positive non-zero integer), Rⱼ, R̅ⱼ̅ being minimum and maximum admissible values, respectively, of said induced property Rⱼ, this monitoring comprising an estimation of an induced property R(u) of a mixture M of previously determined properties x(u), R(u) being a function:
of predetermined properties x(u) of the mixture
of the functions y(x(u)) and z(x(u)) associated with said predetermined properties, said functions being formulated so that, for each property xₖ considered, y(xₖ) and z(xₖ) are functions of S(xₖ, r) where:

$$\begin{matrix}S ( {x}_{k} , r ) = 0.5 \cdot ( 1 + sign ( {x}_{k} - r ) ) & ( 1 ) \\ sign ( {x}_{k} - r ) = \{ \begin{matrix}- 1 {x}_{k} \leq r \\ 1 {x}_{k} > r\end{matrix} & ( 2 )\end{matrix}$$

r being equal to mₖ or Mₖ.

The method according to the invention makes it possible to monitor properties of mixtures such as mixtures of petroleum products, wine, cements, paints, etc. Stated otherwise, the invention makes it possible to monitor properties of mixtures whose constituents are solid and/or liquid and/or gaseous.

The properties x(u) of the mixture can be physical, chemical, qualitative and/or quantitative properties, and/or be qualitatively and/or quantitatively characterized chemical compounds. They are, in particular, dependent on the properties (defined by the matrix B) of the constituents and quantities (defined by the recipe u) of mixed constituents.

The induced properties R(u) of the mixture can be physical, chemical, qualitative and/or quantitative properties and/or be qualitatively and/or quantitatively characterized chemical compounds. These induced properties correspond to a particular behavior of the mixture during its use. It may thus entail emissions of volatile chemical compounds during the use of the mixture. Stated otherwise, the induced properties cannot be determined by direct measurement of the mixture.

The method according to the invention thus comprises the following steps:

(A) a step of determining the properties x(u) of the mixture M. This determination can be carried out by direct measurements of the mixture or by a determination of the properties of the constituents used to manufacture the mixture and by laws of mixing based on B and u. The matrix B of the properties of the constituents can in particular be obtained by measurements of the constituents or by estimation. This matrix B or the properties x(u) can thus be recorded in a memory. The properties of the mixture M are named either x(u) or x(B, u).

(B) a step of estimating the at least one induced property R(u) of the mixture M, R(u) being dependent:
on a set of predetermined properties x(u) of the mixture,
on the functions y(x(u)) and z(x(u)) associated with these predetermined properties, said functions being formulated so that, for each property xₖ considered—namely each property xₖ of the set of predetermined properties x(u)−y(xₖ) and z(xₖ) are functions of S(xₖ, r) where:

$$\begin{matrix}S ( {x}_{k} , r ) = 0.5 \cdot ( 1 + sign ( {x}_{k} - r ) ) & ( 1 ) \\ sign ( {x}_{k} - r ) = \{ \begin{matrix}- 1 {x}_{k} \leq r \\ 1 {x}_{k} > r\end{matrix} & ( 2 )\end{matrix}$$

r being equal to mₖ or Mₖ.

Stated otherwise, in the course of this step (B), the functions y(x(u)) and z(x(u)) of a set of predetermined properties x(u) of a mixture are estimated as a function of S(xₖ, r) and an estimation of R(u) is deduced therefrom.

(C) A step of determining a recipe u so that at least one, for example each, previously estimated induced property Rⱼ, j=1, . . . , q (with q a non-zero positive integer) of said mixture M obtained complies with specifications Rⱼ≦Rⱼ(u) and/or Rⱼ(u)≦R̅ⱼ, Rⱼ, R̅ⱼ̅ being minimum and maximum admissible values, respectively, of said induced property Rⱼ.

(D) A step of generating at least one signal for control of means for distributing the constituents of the mixture M, this signal being generated as a function of the recipe u determined in the previous step.

(E) A step of transmitting said at least one control signal to means for distributing the constituents so as to obtain a mixture M. A mixture M complying with the specifications relating to the induced properties R(u) is thus obtained.

Thus, it is possible to control or steer the manufacture of a mixture so that one or more of its induced properties comply with predetermined specifications. In particular, provision may be made to repeat steps (A) to (E) at predetermined time intervals. For example, at a time tᵢ=0, steps (A) and (B) can in particular be implemented for an initial mixture Mᵢ obtained by means of a recipe u₀, step (C) making it possible to determine a new recipe uᵢ₊₁ to be applied at a time tᵢ₊₁=tᵢ+Δt. Steps (A) to (E) being thereafter repeated using the properties of the mixture Mᵢ₊₁ obtained by means of the recipe uᵢ₊₁, so as to determine a new recipe uᵢ₊₂, and so on and so forth. Provision may also be made for regular reinitialization of the recipe u to be applied and of the properties of the mixture obtained.

The induced property R(u) mentioned in the present invention depends in a usual manner on determined properties of the mixture and the functions y(x(u)) and z(x(u)) associated with these determined properties, y(x(u)) and z(x(u)) being such that they comply with disjunctive conditions which, for each property xₖ, allocate to yₖ=y(xₖ) at least one value chosen from among xₖ, mₖ, Mₖ, as a function of one or more inequalities between said value xₖ and at least one value mₖ, Mₖ, where mₖ, Mₖ are predefined constants and xₖ is the value of the property k for a recipe u. Stated otherwise, this function R(u) is nonlinear, non-differentiable, and requires a large number of constraints in the known writings of the prior art, thereby complicating its integration into a monitoring method.

These disjunctive conditions may for example be written in the following manner for a property xₖ:

if xₖ<mₖ, then yₖ=mₖ and zₖ=xₖ−mₖ (3)

if xₖ≧mₖ AND xₖ≦Mₖ, then yₖ=xₖ and z=0 (4)

if xₖ>Mₖ, then yₖ=Mₖ and zₖ=xₖ−Mₖ (5)

According to the properties, one, two or three disjunctive conditions of type (3) to (5) may apply.

For a property having to comply with the three disjunctive conditions (3), (4), (5), the functions y(xₖ) and z(xₖ) may be written:

y(xₖ)=(1−S(xₖ,mₖ))·m+S(xₖ,mₖ)·(1−S(xₖ,Mₖ))·x+S(xₖ,Mₖ)·Mₖ (6)

z(xₖ)=(1−S(xₖ,mₖ))·(xₖ−mₖ)+S(xₖ,Mₖ)·(xₖ−Mₖ) (7)

The invention thus presents the advantage of reformulating these disjunctive conditions in the form of functions y(x(u)) and z(x(u)) for each property xₖ. This reformulation of disjunctive conditions in the form of functions makes it possible to simplify the estimation of the induced property R by reducing the number of variables with respect to the estimations translating the disjunctive conditions into boolean variables. In particular, these functions y(x(u)) and z(x(u)) can be injected directly into a function calculating the value of the emission property R. The reformulation thus makes it possible to simplify the estimation of an emission property R without modifying it, thereby making it possible to increase the speed of the data processing, enabling on-line integration.

Stated otherwise, the method according to the invention makes it possible to formulate disjunctive constraints in a simple manner and to inject variables subject to these disjunctive constraints into a function, thus allowing these variables to be taken into account more simply. It will thus be noted that the estimation of the induced property such as defined in the method according to the invention is applicable to any model using disjunctive constraints, whether involving mixtures properly speaking or a quantity other than a mixture dependent on properties of constituents and exhibiting induced properties. Advantageously and in a nonlimiting manner, these induced properties Rⱼ can be determined on the basis of a model, in particular of the complex model defined by the American Environmental Protection Agency (EPA), the mixture M being a mixture of hydrocarbons, for example a gasoline.

Advantageously and in a nonlimiting manner, in the estimation of said induced property R(u), the function S(xₖ, r) can be approximated by a sigmoid function SC(xₖ, r):

SC(xₖ,r,a)=0.5·(1+tan h(a·(xₖ−r)) (8)

with a, predetermined coefficient for the property xₖ corresponding to the slope of the curve SC(xₖ, r) when xₖ=r.

Such an approximation makes it possible to render the functions y(x(u)) and z(x(u)) differentiable. Each induced property R can then become a continuous and differentiable function, thereby making it possible to facilitate on-line monitoring of this property by simplifying the monitoring of its divergence or convergence to a setpoint value.

In particular, the coefficient a can be chosen so that SC(xₖ, r)=S(xₖ, r) except over an interval r−δ<xₖ<r+δ where δ is chosen so that 2δ is less than an error in determining the property xₖ. It is thus possible to take account of the precision of the determination of a property xₖ, precision corresponding for example to an error of measurement of an appliance or to the precision of an estimated value.

In particular, sufficient calculation precision can be obtained by choosing the coefficient a less than or equal to δ, advantageously less than or equal to δ/5, preferably less than or equal to δ/7, for example equal to δ/7.

Advantageously and in a nonlimiting manner, the method according to the invention can provide that a mixture M of recipe u complies with the specifications Rⱼ(u)≦R̅ⱼ̅ if and only if:

F(u)=Σ_{R}_{ⱼ}_{ε{R}_{₁}_{, . . . , R}_{ₚ}_{}}[Rⱼ>Rⱼ]·(Rⱼ(u)−Rⱼ)=0 (9)

where [Rⱼ>R̅ⱼ]=1 if Rⱼ>R̅ⱼ̅ and [Rⱼ>R̅ⱼ]=0 otherwise.

As a variant, the method according to the invention can provide that a mixture M of recipe u complies with a specification Rⱼ≦Rⱼ(u) if and only if:

F(u)=Σ_{R}_{ⱼ}_{ε{R}_{₁}_{, . . . R}_{ₚ}_{}}[Rⱼ<Rⱼ]·(Rⱼ−Rⱼ(u))=0 (9′)

where [Rⱼ≦Rⱼ]=1 if Rⱼ<Rⱼ and [Rⱼ<Rⱼ]=0 otherwise.

According to yet another variant, the method according to the invention can provide that a mixture M of recipe u complies with a specification Rⱼ(u)≦R̅ⱼ̅ and Rⱼ(u)≧Rⱼ, if and only if:

F(u)=Σ_{R}_{ⱼ}_{ε{R}_{₁}_{, . . . R}_{ₚ}_{}}(·[Rⱼ>R̅ⱼ̅]·(Rⱼ(u)−R̅ⱼ̅)+·[Rⱼ<Rⱼ]·(Rⱼ(u)−Rⱼ))=0 (9″)

where:

[Rⱼ>R̅ⱼ]=1 if Rⱼ>R̅ⱼ̅ and [Rⱼ>R̅ⱼ]>=0 otherwise

[Rⱼ<Rⱼ]=1 if Rⱼ<Rⱼ and [Rⱼ<R̅ⱼ]=0 otherwise.

In particular, Rⱼ(u) is determined by means of said estimation using the function S(xₖ, r).

This function F(u) (9, 9′, 9″), which uses a technique inspired by Lagrange multipliers, makes it possible to verify in a simple manner whether a constraint Rⱼ(u)≦R̅ⱼ̅ and/or Rⱼ≦Rⱼ(u) is not complied with. Indeed, at least one constraint Rⱼ(u)≦R̅ⱼ̅ and/or Rⱼ≦Rⱼ(u)) is violated if and only if F(u)>0. The use of the function F(u) thus makes it possible to further simplify the monitoring and consequently the processing times.

In particular, the formulation of the function F(u) enables penalties to be taken into account when a constraint Rⱼ(u)≦R̅ⱼ̅ and/or Rⱼ(u)≧Rⱼ is not complied with.

Thus, the introduction of a term r into the function F(u) (9) according to:

F(u, π)=Σ_{R}_{ⱼ}_{ε{R}_{₁}_{, . . . , R}_{ₚ}_{}}π̅_{R}_{ⱼ}·[Rⱼ>R̅ⱼ̅]·(Rⱼ(u)−R̅ⱼ̅)=0 (10)

makes it possible to take into account a penalty associated with the induced property Rⱼ when the latter does not comply with the specification Rⱼ(u)≦R̅ⱼ̅, this term π̅_{R}_{ⱼ} then being a non-zero positive parameter representative of a penalization.

The introduction of this term π̅_{R}_{ⱼ} into the function F(u) (9) also makes it possible not to take an induced property Rⱼ into account in the calculation of F(u, π), for example when the specification Rⱼ(u)≦R̅ⱼ̅ is systematically satisfied for any recipe. In order for such an induced property Rⱼ not to be taken into account, it suffices indeed to choose π̅_{R}_{ⱼ}=0.

For the sake of simplifying the processing, the term [Rⱼ>R̅ⱼ̅] of the function F(u) can also be approximated by a sigmoid function SC(Rⱼ, R̅ⱼ̅):

SC(Rⱼ,R̅ⱼ,a)=0.5(1+tan h(a(Rⱼ−R̅ⱼ̅))) (11)

with a, predetermined coefficient for the emission property Rⱼ corresponding to the slope of the curve SC(Rⱼ, R̅ⱼ̅) when Rⱼ=R̅ⱼ̅.

In this case, a can also be determined in such a way that SC(Rⱼ, R̅ⱼ̅)=[Rⱼ>R̅ⱼ̅] except over an interval R̅ⱼ̅−δ<Rⱼ<R̅ⱼ̅+δ where δ is chosen so that 2δ is less than an error in determining the property Rⱼ, for example an acceptable error.

Similarly, as a variant, a parameter π_{R}_{ⱼ} representative of a penalization can be associated with the property Rⱼ when the latter does not comply with the specification Rⱼ≦Rⱼ(u). In this case, a mixture M of recipe u complies with the specifications Rⱼ≦Rⱼ(u) if and only if:

$$F ( u , {\underline{π}}_{{R}_{j}} ) = {Σ}_{{R}_{j} ∈ \{ {R}_{1} , … , {R}_{p} \} {\underline{π}}_{{R}_{j}}} \cdot [ {R}_{j} < {\underline{R}}_{j} ] \cdot ( {\underline{R}}_{j} - {R}_{j} ( u ) ) = 0 \qquad ( {10}^{′} )$$

If the constraint is always realized for a property, the associated term π_{R}_{ⱼ} can then be chosen equal to zero.

Similarly, the function F(u) (9″) can take into account parameters representative of a penalization associated with the property Rⱼ when the latter does not comply with the specification Rⱼ(u)≦R̅ⱼ̅ and Rⱼ≦Rⱼ(u). The function F(u) can then be written:

$$F ( u , π ) = {Σ}_{{R}_{j} ∈ \{ {R}_{1} , … , {R}_{p} \}} ( {\overline{π}}_{{R}_{j}} \cdot [ {R}_{j} > \overline{{R}_{j}} ] \cdot ( {R}_{j} ( u ) - \overline{{R}_{j}} ) + {\underline{π}}_{{R}_{j}} \cdot [ {R}_{j} < {\underline{R}}_{j} ] \cdot ( {R}_{j} ( u ) - {\underline{R}}_{j} ) ) = 0 \qquad ( {10}^{″} )$$

Note that the terms π̅_{R}_{ⱼ}, π_{R}_{ⱼ} associated with each constraint, Rⱼ(u)≦R̅ⱼ̅, Rⱼ≦Rⱼ(u), respectively, may be identical or different.

As in the previous case, the term [Rⱼ<Rⱼ] of the function F(u) can also be approximated by a sigmoid function SC(Rⱼ, Rⱼ):

SC(Rⱼ,Rⱼ,a′)=0.5(1+tan h(a′(Rⱼ−Rⱼ))) (11′)

with a′ predetermined coefficient for the emission property Rⱼ corresponding to the slope of the curve SC(Rⱼ, Rⱼ) when Rⱼ=Rⱼ.

In this case, a′ can also be determined in such a way that SC(Rⱼ, Rⱼ)=[Rⱼ<Rⱼ] except over an interval Rⱼ−δ<Rⱼ≦Rⱼδ where δ is chosen so that 2δ is less than an error in determining the property Rⱼ, for example an acceptable error.

Advantageously and in a nonlimiting manner, the functions F(u) (9, 9′, 9″) or F (u, π) (10, 10′, 10″) defined hereinabove can be used in the course of a step of optimizing the recipe u for manufacturing a mixture so as to simplify the solving of an optimization problem and to thus reduce the time required for solving this problem.

The method according to the invention can thus comprise a step of optimizing the recipe u in the course of which a solution is sought to an optimization problem taking into account a group of constraints on the recipes u, a group of constraints on the properties x and a group of constraints on the induced properties Rⱼ, said optimization problem being defined by:

$$\{ \begin{matrix}min F ( u ) ( or min F ( u , π ) ) \\ {\underline{u}}_{IU} \leq u \leq {\overline{u}}_{IU} \\ \underline{p} ( {L}_{P} ) \leq x ( {L}_{P} ) , x ( {U}_{P} ) \leq \overline{p} ( {U}_{P} )\end{matrix} \qquad ( 12 )$$

where

F(u) is such as defined above by relations (9), (9′) or (9″) and optionally modified by the sigmoid function SC(Rⱼ, R̅ⱼ̅) defined by relation (11) or (11′),

F(u, π) is such as defined above by relations (10), (10′) or (10″) and optionally modified by the sigmoid function SC(Rⱼ, R̅ⱼ̅) defined by relation (11) or (11′),

u_{IU}≦u≦ū_{IU} represents the constraints on the recipes, with u_{IU} and ū_{IU}, minimum and maximum values respectively of a recipe u for a whole group of constraints IU,

p(L_{P})≦x(L_{P}),x(U_{P})≦p̅(U_{P}) represents the constraints on the properties x of the mixture, with p(L_{P}) and p̅(U_{P}) minimum and maximum values respectively of a property x for a whole group of constraints L_{P}, U_{P} ⊂{1, . . . , P} where P: number of properties tracked (monitored or taken into account).

This optimization step uses, for the search for a solution u₀ to the optimization problem (12), the value of the function F(u₀) and the value of its derivative, or the value of the function F(u₀, π) and the value of its derivative, said derivative value being determined by expressing said derivative on the basis of the estimation of said induced property R(u) such as defined according to the invention in which the function S(xₖ, r) is approximated by the sigmoid function SC(xₖ, r) (8), said value of the function F(u₀) or F(u₀, π) being determined on the basis of said estimation of said induced property R(u) in which the function S(xₖ, r) is optionally approximated by the sigmoid function SC(xₖ, r) (8).

This optimization problem (12) is solvable when there exists an optimal solution u₀ for which F(u₀)=0 or F(u₀, π)=0.

The functional expression of R(u) makes it possible to ascertain the gradient of the function F(u) or of the function F(u, π) and thus to simplify the solving of the problem (12).

It will be noted that the functional expression of R(u) in which the function S(xₖ, r) is approximated by the sigmoid function SC(xₖ, r) (8) might not be used in solving the problem (12) for determining the value F(u₀) or F(u₀, π). The determination of F(u₀) or F(u₀, π) is then performed by using the sign function S(xₖ, r) defined by relations (1) and (2).

This problem (12) thus integrates constraints on the recipes, on the properties of the mixture and on the properties of emissions of the mixture.

The constraints on recipes u can be chosen from among:
Regulation and Monitoring (RS) constraints, of minimum value u_{RS}=0, and of maximum value ū_{RS}=1,
hydraulic constraints (H) imposed by the capacities of the mixing installation, of minimum value u_{H} and of maximum value ū_{H},
availability constraints (D) imposed by the available volumes of the constituents used to make the mixture, of minimum value u_{D} and of maximum value ū_{D},
intersection constraints (HD) in respect of the constraints H and D, of minimum value u_{HD}=max(u_{H}, u_{D}), and of maximum value ū_{HD}=min(ū_{H}, ū_{D}).

The choice of a group of constraints on the recipes u can thus be indicated by the symbol IUε{RS, H, D, HD},

u_{IU}≦u≦ū_{IU} (13)

The constraints on the properties of the mixtures can be of the form:

p=max(x,c)≦x≦min(x̅,c̅)=p̅ (14)

where:
c, c̅, are respectively minimum and maximum values that the properties x(u) of the mixture must comply with; this entails for example specifications chosen by the manufacturers or imposed by norms,
x, x̅ are respectively minimum and maximum values that the properties x(u) of the mixture must comply with and which correspond for example to a domain of validity of the function R(u). For example, these values x, x̅ can correspond to the values m, M of the disjunctive conditions. For example, they can correspond to the limits of the domain of validity of the 80.45EPACM complex model.

Equation (14) thus makes it possible to take into account at one and the same time customarily existing constraints, for example regulatory constraints, on properties, as well as additional constraints, for example induced by the properties of the mixture, such as these constraints on the emissions of a mixture. In the example of the application to the 80.45EPACM model, these additional constraints are defined (see table 1 in the description of the figures).

It is commonplace to work with subsets of these constraints. Typically, when not all the constraints are satisfiable, it is sought to satisfy only the hard constraints.

A group of constraints on the properties can thus be indicated by two sets of indices, “L” for lower and “U” for upper, of properties L_{P}, U_{P}⊂ {1, . . . , P}. The current constraints may thus be written in the form:

p(L_{P})≦x(L_{P}), x(U_{P})≦p̅(U_{P}) (15)

Advantageously and in a nonlimiting manner, the method of monitoring of the present invention can thus comprise:

(a) a step of defining an instance of mixture in which there is defined:
a matrix B of the properties of the n constituents,
a set IU of constraints on the recipes u such that u_{IU}≦u≦ū_{IU}, with u_{IU}, ū_{IU} minimum, respectively maximum, values of said set IU,
a set L_{P}, U_{P}⊂{1, . . . , P}, where P: number of properties tracked, of minimum values L_{P} and maximum values U_{P} of the properties x,
optionally a penalty vector π̅_{R}_{ⱼ} and/or π_{R}_{ⱼ} for a property Rⱼ,

(b) optionally, a step of searching for feasible mixtures, so as to simplify step (c), in the course of which, for Rⱼε{R₁, . . . , Rₚ}, we solve

$$\begin{matrix}\{ \begin{matrix}max {R}_{j} ( u ) \\ {\underline{u}}_{IU} \leq u \leq {\overline{u}}_{IU} \\ \underline{p} ( {L}_{p} ) \leq x ( {L}_{p} ) , x ( {U}_{p} ) \leq \overline{p} ( {U}_{p} )\end{matrix} \\ and \text{/} or & ( 16 ) \\ \{ \begin{matrix}min {R}_{j} ( u ) \\ {\underline{u}}_{IU} \leq u \leq {\overline{u}}_{IU} \\ \underline{p} ( {L}_{P} ) \leq x ( {L}_{P} ) , x ( {U}_{P} ) \leq \overline{p} ( {U}_{P} )\end{matrix} & ( {16}^{′} )\end{matrix}$$

in which the value of the function R(u) and the value of its derivative are used for the search for a solution u to the optimization problem (16, 16′), said derivative value being determined by expressing said derivative on the basis of the estimation of said induced property R(u) such as defined according to the invention in which the function S(xₖ, r) is approximated by the sigmoid function SC(xₖ, r) (8), said value of the function R(u) being determined on the basis of said estimation of said induced property R(u) in which the function S(xₖ, r) is optionally approximated by the sigmoid function SC(xₖ, r) (8),

(c) an optimization step according to the invention in the course of which an optimal solution u₀ is sought to the optimization problem (12) defined above:

$$\{ \begin{matrix}min F ( u ) or min F ( u , π ) \\ {\underline{u}}_{IU} \leq u \leq {\overline{u}}_{IU} \\ \underline{p} ( {L}_{P} ) \leq x ( {L}_{P} ) , x ( {U}_{P} ) \leq \overline{p} ( {U}_{P} )\end{matrix} \qquad ( 12 )$$

and if F(u₀)>0 or F(u₀, π)>0, the previous steps are repeated while modifying the sets of constraints and/or the constituents of the step of defining an instance of mixture.

Otherwise, said optimal recipe u₀ is applied.

Step (a) makes it possible to define an instance of mixture. Stated otherwise, this step defines which properties must be monitored and to what extent, for example as a function of the available constituents, of the installation used, of the model used for estimating the induced properties R, etc.

The optional step (b) makes it possible to determine a space of feasible mixtures which satisfy the constraints on the recipes u, the properties x and the properties R.

In the course of this step (b) it is optionally possible to verify whether Rⱼ(uₘₐₓ)≦R̅ⱼ̅, and, if such is the case, to impose π̅_{R}_{ⱼ}=0, with uₘₐₓ←argmax Rⱼ(u), u satisfying the set of constraints (16). Stated otherwise, uₘₐₓ is the recipe vector u giving the maximum value to Rⱼ. This makes it possible not to take into account in step (c) a property Rⱼ for which the relation Rⱼ(uₘₐₓ)≦R̅ⱼ̅ is always satisfied, thus making it simpler to solve the problem of step (c).

Similarly, as a variant or in combination, in step (b), it is possible to verify whether Rⱼ≦Rⱼ(uₘᵢₙ), and, if such is the case, to impose π_{R}_{ⱼ}=0, with uₘᵢₙ←argmin Rⱼ(u), u satisfying the set of constraints (16′). Stated otherwise, uₘᵢₙ is the recipe vector u giving the minimum value to Rⱼ.

Step (c) thereafter makes it possible to determine, optionally in this space of feasible mixtures, an optimal recipe u₀ of the optimization problem (12), and then verifies whether this optimal recipe u₀ complies with the specifications relating to the properties of the emissions R, this being the case if F(u₀)=0 or F(u₀, π)=0.

If such is the case, the optimal recipe u₀ can be used to produce the mixture.

If such is not the case, stated otherwise if F(u₀)>0 or F(u₀, π)>0, steps (a) to (c) are repeated while modifying the sets of constraints and/or the constituents of the step (a) of defining an instance of mixture.

If the optimal recipe u₀ complies with the specifications relating to the properties of the induced properties R, stated otherwise if F(u₀)=0 or F(u₀, π)=0, the method can comprise the following additional step (d), in which:
at least one value Fᵢ(u₀) is calculated where Fᵢ is a function taking into account an additional constraint such as the cost or the quality of the mixture,
an optimal solution (S*, T*, u*) of a second optimization problem is found

$$\{ \begin{matrix}min G ( S , T , u ) = a \cdot S + b \cdot T + w \cdot F ( u , π ) \\ {F}_{1} ( u ) \leq S \cdot {F}_{1} ( {u}_{0} ) \\ {F}_{2} ( u ) \leq T \cdot {F}_{2} ( {u}_{0} ) \\ 0 < S , T \leq 1 \\ {\underline{u}}_{IU} \leq u \leq {\overline{u}}_{IU} \\ \underline{p} ( {L}_{P} ) \leq x ( {L}_{P} ) , x ( {U}_{P} ) \leq \overline{p} ( {U}_{P} )\end{matrix} \qquad ( 17 )$$

where a and b are predetermined weightings of F₁(u₀) and F₂(u₀), in particular chosen by the user. Examples of functions F₁ are detailed below.

In this step, the value of the function F(u*) and the value of its derivative or the value of the function F(u*, π) and the value of its derivative are used for the search for a solution u* to the optimization problem (17), said derivative value being determined by expressing said derivative on the basis of the estimation of said induced property R(u) in which the function S(xₖ, r) is approximated by the sigmoid function SC(xₖ, r) (8), said value of the function F(u*) or F (u*, π) being determined on the basis of said estimation of said induced property R(u) in which the function S(xₖ, r) is optionally approximated by the sigmoid function SC(xₖ, r) (8),
if F (u*, π)=0, the recipe u* is applied, otherwise a point u₁ is found in]u₀, u*] such that F(u₁, π)=0 and u₁ is applied.

This step (d) thus makes it possible to take additional constraints into account via the functions Fᵢ.

These functions Fᵢ are for example:
a cost function F₁(u)=C^{T}u, where C^{T} is a cost vector of the constituents of the mixture,
a function indicative of the over-quality of a mixture F₂(u)=∥x(u)−x⁰∥, where x⁰ is a vector of the properties of a predetermined ideal target mixture.

The method according to the invention can be used for the monitoring, in particular for the optimization, of mixtures of petroleum products, but it can also apply to mixtures of products such as wines, cements, paints, etc.

The method according to the invention can thus be a monitoring method in which:
the mixture M is a mixture of hydrocarbons, for example a gasoline,
the properties x of said mixture are chosen at least from among the oxygen content, the sulfur content, the vapor pressure, the distillation fraction at 200° F., the distillation fraction at 300° F., the aromatics content, the benzene content, the olefins content, the methyl ethylbenzene content, the ethyl terbutyl ether content, the tertioamylathylether content,
the induced properties Rⱼ of the mixture are chosen from among the emissions (V) of volatile organic compounds, the emissions (N) of nitrogen oxides and the emissions (T) of toxic compounds.

These induced properties Rⱼ can then for example be determined on the basis of the 80.45EPACM complex model defined for reformulated and conventional gasolines by the American Environmental Protection Agency (EPA) in document e-CFR§80.45. It will be noted that in this document, specifications on the induced properties are given only for so-called reformulated and conventional gasolines. However, the present invention can be applied to gasolines other than the so-called reformulated gasolines of 80.45EPACM, through an appropriate choice of constraints on the induced properties. In the same manner, functions and constraints similar to those presented in 80.45EPACM for reformulated gasolines could be defined for other formulations of hydrocarbons (diesel, jet fuel, etc.) and implemented by the method according to the invention. Thus, the present invention is not limited to the application of the 80.45EPACM model. Other models could be used and/or other constraints on the properties can be used.

The properties x of the mixture can in particular be measured, for example by a set of on-line analyzers, in particular in a periodic manner (by tapping off product in a sampling loop).

The measurement apparatus concerned can be specific for a given property (sulfur meter, densimeter, vapor pressure etc.). This measurement apparatus can also make it possible to retrieve the measurement value of several different properties on the basis of one and the same product sample (analyzer of near-infrared spectral type).

In the absence of a measurement apparatus, calculated (simulated or inferential) estimations can be used to determine certain properties of the mixture. This calculation can combine the values of the properties measured on each constituent of a mixture with the ratios (by volume or by mass) of incorporation in the mixture, by implementing particular transformation laws (mixing laws) specific to each property considered.

The values of the properties measured on each constituent of a mixture can be analyzed in the laboratory (after sampling from a receptacle), in the case corresponding to mixture constituents available in intermediate receptacles feeding the mixers.

For the mixture constituents arriving at the mixer (mixture collector) without passing through an intermediate receptacle, on-line measurements, for example provided in a periodic manner, on the stream concerned by on-line analyzers can also be utilized as measured data to feed the inferential calculation of certain inputs of the model.

Finally, standard values can also be allocated according to case, when the variability of the property is negligible.

There is furthermore proposed a computer program product comprising instructions for performing the steps of the method described hereinabove when these instructions are executed by a processor. This program may for example be stored on a memory support of hard disk type, downloaded, or the like.

The invention also relates to a system for monitoring properties of a mixture M of n constituents, said system being linked to means for distributing constituents to a unit for mixing constituents, comprising:
means for determining the properties x(B, u) of said mixture, denoted either x(B, u) or x(u), where:
x(u)=[x₁, . . . xₖ] is a vector of k properties of the mixture M, k a non-zero positive integer,
u=[u₁, . . . uₙ] is a recipe vector and uᵢ, i=1, . . . , n, indicates the proportion of the ith constituent in the mixture M,
B=[B1, . . . , Bₙ] is a matrix of the characteristics of the n constituents,
a management system comprising:
   means for receiving said properties x(B, u)
   storage means for storing the values of the properties provided by the receiving means, and at least one model for determining a mixture property R(u)=R(y(x(u)), z(x(u))) induced by the properties x(B, u), where

z(x(u))=y(x(u))−x(u)
y(x(u)) is a vector of properties of the mixture
and where y(x(u)) and z(x(u)) are such that they comply with disjunctive conditions which, for each property xₖ, allocate to yₖ at least one value chosen from among xₖ, Mₖ, Mₖ, as a function of one or more inequalities between said value xₖ and at least one value Mₖ, Mₖ, where Mₖ, Mₖ are predefined constants and xₖ is the value of the property k for a recipe u,
processing means designed:
   to determine a recipe u of a mixture M so that the mixture complies with specifications R_{j≦}Rⱼ(u) and/or Rⱼ(u)≦R̅ⱼ̅ for each property Rⱼ, j=1, . . . , p (with p a non-zero positive integer), Rⱼ, R̅ⱼ̅ being admissible minimum and maximum values, respectively, of said induced property, by using an estimation of said induced property R(u) of a mixture M whose properties x(u) are provided by the determining means, said estimation using, for a set of determined properties of the mixture, a formulation of functions y(x(u)) and z(x(u)) so that, for each property xₖ considered, y(xₖ) and z(xₖ) are functions of S(xₖ, r), where:

$$\begin{matrix}S ( {x}_{k} , r ) = 0.5 \cdot ( 1 + sign ( {x}_{k} - r ) ) & ( 1 ) \\ sign ( {x}_{k} - r ) = \{ \begin{matrix}- 1 {x}_{k} \leq r \\ 1 {x}_{k} > r\end{matrix} , & ( 2 )\end{matrix}$$

r being equal to mₖ or Mₖ,
   then generate at least one control signal for the distribution means,
   means for transmitting the at least one control signal to the means for distributing the constituents.

This monitoring system is in particular able to implement the method according to the invention according to one or more of the characteristics detailed above.

In the system according to the invention, the processing means can in particular be designed to:
estimate, in particular after reading of the model stored in the storage means, at least one property R(u) of a mixture M whose properties x(u) are provided by the determining means and stored, R(u) being dependent:
   on a set of predetermined properties x(u) of the mixture,
   on the functions y(x(u)) and z(x(u)) associated with these predetermined properties, said functions being reformulated so that, for each property xₖ considered—namely each property xₖ of the set of predetermined properties x(u)−y(xₖ) and z(xₖ) are functions of S(xₖ, r) where:

$$\begin{matrix}S ( {x}_{k} , r ) = 0.5 \cdot ( 1 + sign ( {x}_{k} - r ) ) & ( 1 ) \\ sign ( {x}_{k} - r ) = \{ \begin{matrix}- 1 {x}_{k} \leq r \\ 1 {x}_{k} > r\end{matrix} , & ( 2 )\end{matrix}$$

r being equal to mₖ or Mₖ,
determine a recipe u of a mixture M so that the mixture complies with Rⱼ≦Rⱼ(u) and/or Rⱼ(u)≦R̅ⱼ for at least one, in particular each, property Rⱼ, j=1, . . . , p (with p a non-zero positive integer), Rⱼ, R̅ⱼ̅ being admissible minimum and maximum values respectively of said induced property.

In particular, to estimate at least one property R(u), the processing means can be designed to:
determine the functions y(x(u)) and z(x(u)) of a set of predetermined properties x(u) of a mixture as a function of S(xₖ, r) defined hereinabove by means of equations (1) and (2),
after reading of the model stored in the storage means, deduce therefrom an estimation of R(u),
determine a recipe u of a mixture so that the latter complies with specifications Rⱼ≦Rⱼ(u) and/or Rⱼ(u)≦R̅ⱼ for at least one induced property Rⱼ, j=1, . . . , p (with p a non-zero positive integer), Rⱼ, R̅ⱼ̅ being admissible minimum and maximum values respectively of said induced property.

The means for determining the properties of the mixture can be those described above.

The management system can be, for example, a processor of microprocessor, microcontroller or other type.

The receiving means can for example comprise an input pin, an input port or the like.

The storage means can be a random-access memory or RAM, an EEPROM (Electrically-Erasable Programmable Read-Only Memory), or the like. These storage means can for example store a model, for example the 80.45EPACM complex model established by the EPA, and all the constants used in this model, stated otherwise the various functions of this model as well as the expression of their derivative obtained by the estimation according to the invention.

The processing means can be, for example, a processor core or CPU (Central Processing Unit).

The transmission means can for example comprise an output pin, an output port, or the like.

In particular, the processing means can be designed to determine a recipe u by implementing the method according to the invention such as defined above, and in particular to implement an optimization step according to the invention and/or steps (a) to (c) or (a) to (d) of the method according to the invention described above.

The invention relates finally to a unit for mixing n constituents, comprising means for distributing n constituents into at least one mixture collector and a monitoring system according to the invention.

This mixing unit is more particularly intended for the preparation of mixtures of hydrocarbons, such as gasolines.

### BRIEF DESCRIPTION OF THE FIGURES

The invention is now described by means of examples and with reference to the nonlimiting appended drawings, in which:

FIG. 1 represents a diagram of a mixing unit 100 according to an embodiment of the invention,

FIG. 2 represents a logic diagram of an embodiment of a method according to the invention

FIG. 3 schematically represents the steps of calculating the functions N=NOx(x), V=VOC(x) and T=TOX(x),

FIG. 4 represents a function SC(t, r, a) (A) and its first derivative (B) for the property OXY.

### DETAILED DESCRIPTION OF THE FIGURES

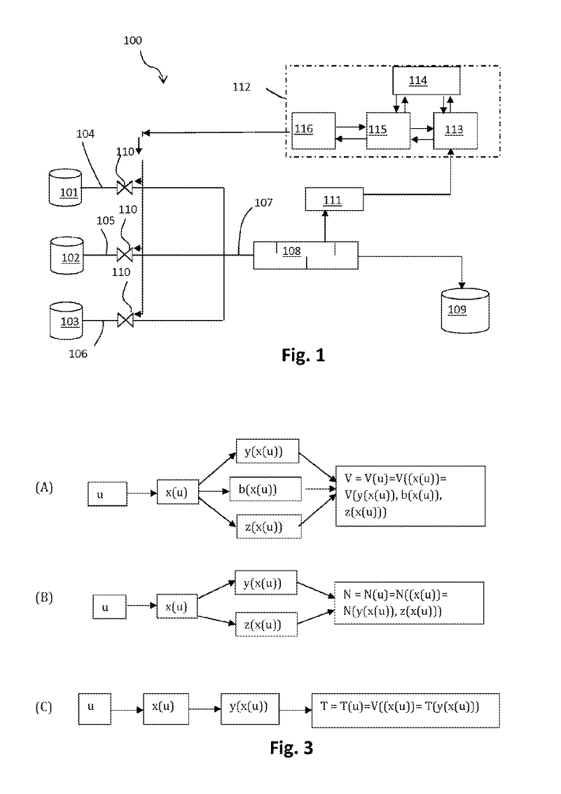

In FIG. 1 is represented a mixing unit 100 for producing a mixture M from constituents or bases. The constituents are contained in receptacles 101, 102, 103, the number of which has been limited to three for convenience of representation. The constituents to be mixed travel through transport pathways 104, 105, 106 to a main pathway 107 provided with a mixture collector or mixer 108, the main pathway conducting the mixture to a destination receptacle 109. Means designated by the reference 110 in FIG. 1 make it possible to control the flowrates of the constituents on each transport pathway. This entails for example flowrate regulators controlling a valve.

Means for determining the properties 111, or means of continuous measurement, make it possible to measure in a repetitive manner the parameters representative of the properties of the mixture in the course of its production. These means 111 consist for example of on-line analyzers connected to the mixer 108 situated on the main pathway 107.

In the case of a mixture of petroleum products, these analyzers measure for example the sulfur content of the mixture (sulfur meter), the octane number (octane engine), the cetane number (cetane engine) etc.

The installation also comprises a management system 112 for managing the proportions (recipe u) of the bases entering the mixture. This management system 112 comprises receiving means 113 linked to the determining means 111, storage means 114, processing means 115 and transmission means 116 linked to the means of control of the flowrates of the constituents 110.

The storage means 114 make it possible to store the values of the properties provided by the receiving means, and at least one model for determining the induced properties of a mixture, including the setpoint or objective values for the various properties of the mixture.

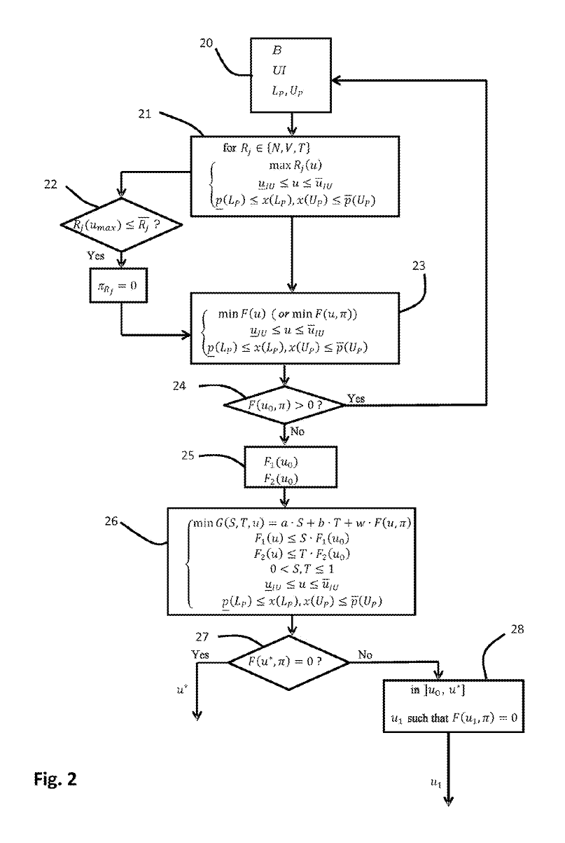

The processing means 115 make it possible to determine a recipe u of the proportions of the bases, which recipe will be transmitted to the control means 110, for example according to the steps described hereinafter with reference to FIG. 2, described for a mixture of hydrocarbons.

The processing means 115 use the data recorded in the storage means 114 to determine a mixture recipe u. In particular, the storage means can contain the specifications of the complex model of 80.45EPACM, as well as the various functions necessary for the monitoring.

FIG. 2 represents a logic diagram of a method for monitoring a mixture M, in particular a mixture of hydrocarbons, for which it is desired that induced properties Rⱼ do not exceed predetermined threshold values, stated otherwise satisfying an inequality Rⱼ(u)

The induced properties Rⱼε{N, V, T}, with N emissions of NOₓ, V the emissions of volatile organic compounds and T the toxic emissions are considered in particular.

Consider a recipe vector uεRⁿ, such that uᵢ, i=1, n, indicates the percentage of the volume of the base Bᵢ in the mixture x. The properties of x are a function of the characteristics of the bases B=[B₁, . . . , Bₙ] and of the recipe u, x=x(B, u).

In the course of a first step 20, an instance of mixture is defined in which are defined:
a matrix B of the properties of the n constituents,
a set IU of constraints on the recipes u such that u_{IU}≦u≦ū_{IU}, with u_{IU}, ū_{IU} minimum, respectively maximum, values of said set IU,
a set L_{P}, U_{P}⊂{1, . . . , P}, where P≧12 number of properties tracked, of minimum values L_{P} and maximum values U_{P} of the properties x,
optionally a penalty vector n for one or more properties R.

These various items of information are for example recorded in the storage means 114, as a function of the mixing unit, of the bases, etc.

In particular, the storage means contain the specifications of the 80.45EPACM complex model as well as the 80.45EPACM functions NOx(u), VOC(u) and TOX(u), modified such as described above in the summary of the invention through the introduction of y and z.

In the course of a second step 21, a search is conducted for feasible mixtures. For this purpose, it is sought to solve, for Rⱼ ε{N, V, T}:

$$\{ \begin{matrix}max {R}_{j} ( u ) \\ {\underline{u}}_{IU} \leq u \leq {\overline{u}}_{IU} \\ \underline{p} ( {L}_{P} ) \leq x ( {L}_{P} ) , x ( {U}_{P} ) \leq \overline{p} ( {U}_{P} )\end{matrix} \qquad ( 16 )$$

This step implements an estimation of the property R, which estimation is determined on the basis of the 80.45EPACM functions NOx(u), VOC(u) and TOX(u), modified according to the invention by means of the sign function S(xₖ, r) and recorded in the storage means 114. More precisely, in a particular embodiment, this step calculates the values Rⱼ(u) corresponding to the 80.45EPACM functions NOx(u), VOC(u) and TOX(u) and also implements a determination of the value of the derivative of the property R, derivative calculated such as detailed in example 2 of gradient calculation, by expressing the property R by means of the sigmoid function SC(xₖ, r) defined in the summary of the invention. The invention is however not limited to this embodiment and the calculation of the values Rⱼ(u) could also be performed by modifying the 80.45EPACM functions NOx(u), VOC(u) and TOX(u) by integrating thereinto the function S(xₖ, r) approximated by the sigmoid function SC(xₖ, r), defined in the summary of the invention.

The solving of this problem (16) can be implemented by the processing means 115.

In particular, it is possible to verify in a step 22 whether Rⱼ(uₘₐₓ)≦R̅ⱼ̅, stated otherwise whether the function F(u, π) vanishes:

F(u, π)=Σ_{R}_{ⱼ}_{ε{N, V, T}}π̅_{R}_{ⱼ}·[Rⱼ>R̅ⱼ̅]·(Rⱼ(u)−R̅ⱼ̅)=0 (10)

In this case, π̅_{R}_{ⱼ}=0 in the function.

In the space of feasible mixtures determined in step (b), the optimization problem (12):

$$\{ \begin{matrix}min F ( u ) ( or min F ( u , π ) ) \\ {\underline{u}}_{IU} \leq u \leq {\overline{u}}_{IU} \\ \underline{p} ( {L}_{P} ) \leq x ( {L}_{P} ) , x ( {U}_{P} ) \leq \overline{p} ( {U}_{P} )\end{matrix} \qquad ( 12 )$$

is thereafter solved in the course of a step 23 and an optimal recipe u₀ is obtained.

The solving of the problem (12) also implements a gradient calculation similar to that presented in example 2 of gradient calculation, by expressing the property R by means of the sigmoid function SC(xₖ, r) defined in the summary of the invention. Furthermore, such as mentioned with reference to the problem (16), the calculation of the values Rⱼ(u) can be performed using the 80.45EPACM functions NOx(u), VOC(u) and TOX(u) modified by integrating thereinto the function S(xₖ, r) or the sigmoid function SC(xₖ, r) defined in the summary of the invention.

In the course of a step 24, it is verified whether F(u₀, π)>0. If such is the case, we return to step 20 and change instance of mixture and/or constituents. If such is not the case, in the course of a step 25, we calculate values F₁(u₀) and F₂(u₀) where the functions F₁ and F₂ are respectively a cost function F₁(u)=c^{T}u and a function indicative of an over-quality F₂(u)=∥x(u)−x⁰∥, already explained in the summary of the invention.

Next, in the course of a step 26, an optimal solution (S*, T*, u*) is sought to the optimization problem (16):

$$\{ \begin{matrix}min G ( S , T , u ) = a \cdot S + b \cdot T + w \cdot F ( u , π ) \\ {F}_{1} ( u ) \leq S \cdot {F}_{1} ( {u}_{0} ) \\ {F}_{2} ( u ) \leq T \cdot {F}_{2} ( {u}_{0} ) \\ 0 < S , T \leq 1 \\ {\underline{u}}_{IU} \leq u \leq {\overline{u}}_{IU} \\ \underline{p} ( {L}_{P} ) \leq x ( {L}_{P} ) , x ( {U}_{P} ) \leq \overline{p} ( {U}_{P} )\end{matrix} \qquad ( 17 )$$

where a and b are weightings of F₁(u₀) (cost of the mixture) and F₂(u₀) (over-quality of the mixture).

In the course of a step 27, it is verified whether F (u*, π)=0. If yes, the optimal recipe u* found is applied. Otherwise, in the course of a step 28, a point u₁ is found in]u₀, u*] such that F(u₂, π)=0 and u₁ is applied.

The set of steps 20 to 28 can be implemented by the processing means 115, using the data recorded in the storage means 114.

Taking the disjunctive conditions into account in the form of differentiable functions makes it possible to obtain processing times of the order of 0.0025 s of the problem (12) using an Intel® Core™ i5 CPU, 2.4 GHZ 32-bit computer with 3 GB of memory using fmincon from Matlab, thereby making it possible to use the monitoring method according to the invention on-line, in the course of manufacturing a mixture. The method and the device according to the invention thus make it possible to monitor on-line the emission properties of a mixture as well as the traditionally regulated properties of a mixture such as a gasoline.

Such on-line monitoring was not possible with the existing approaches for the reasons set forth hereinafter.

The existing approaches in fact calculate the values of the emissions R (R=NOX, VOC, TOX) as a function of the properties x of a mixture and not of the recipe u which produces this mixture by using the constituents B. Therefore, R is not B u but rather a compound function R(x(B, u)). This function R is defined:
1. In a domain X of the space of the properties x;
2. For the needs of calculating the emissions, the domain X is a partition
   X=X₁∪X₂∪ . . . ∪X_{N};
3. The subsets Xᵢ, i=1, . . . , N are convex. Their interiors are of empty intersection;
4. The function R(x) is continuous on X but non-differentiable on the boundary of Xᵢ, i=1, . . . , N.

The number of divisions N may be large. By way of example, for a number of properties (dimension of x), n=20, and for two thresholds m, M per property, each interval is divided into 3 parts and we would have N=3ⁿ≈10¹⁰.

The current calculations thus proceed in two steps:
Step 1: find Xᵢ, i=1, . . . , N such that xεXᵢ. Optionally transform x into yεXⱼ and calculate z=y−x by following logical tests dependent on Xᵢ.
Step 2: calculate, R(x)=fⱼ(y,z).

Step 1

As regards step 1, it should be noted that a direct approach would require the verification of N binary clauses, N perhaps being large. The current approaches carry out step 1 through a verification of satisfiability of disjunctive constraints. By way of indication, the current procedures may lead to a large number of variables, for example 15 to 20 binary variables, 50 to 100 continuous variables, 100 to 200 mixed constraints, or indeed some hundred or so linear/bilinear constraints.

The present invention makes it possible to transform x into yεXᵢ and calculates z=y−z by carrying out for example:

2 logical tests (S(xₖ, mₖ), S(xₖ, Mₖ)), k=1, . . . , n

8 additions/subtractions (see equations (6) and (7))

5 multiplications (see equations (6) and (7))

Thus, the complexity in terms of calculation time of step 1 of the approach according to the present invention is O(n), n being the dimension of x. This is much faster than the complexity of satisfiability of the mixed constraints of current approaches.

Step 2

As regards step 2, the current approaches do not directly carry out regulation of the emissions R(x). These approaches seek to minimize the normalized euclidian distance between x(u) and a reference gasoline xb (baseline-reference). This relies on the unverified assumption:

“if the current mixture x(u) is close to xb then R(x(u)) must be close to R(xb)”

Furthermore, the current approaches cannot carry out direct regulation of R(u)=R(x(u)) since they merely calculate the function R(x) which is non-differentiable (see earlier).

In the present invention, sigmoid functions are introduced to obtain a function p(u) such that:
ρ(u)=R(x(u)) for x(u) “far” from the boundaries of Xᵢ, i=1, . . . , N;
ρ(u) differs from R(x(u)) only on a “slender” zone around the boundaries of Xᵢ, i=1, . . . , N. The thickness of this zone is monitored by the precision of measurement ε of the properties of the vector x. The mass of this layer where ρ(u)≠R(x(u)) is 0(ε)—negligible in practice;
ρ(u) is differentiable. Its gradient at any recipe point u is calculable. Consequently, it is easy to carry out regulation of ρ(u) on-line just like for any conventional property of a mixture.

Thus, the present invention provides the following advantages with respect to current approaches:
gain in calculation time;
possibility of regulating on-line ρ(u) which is equal to R(u) except on a set of mass 0(E).

### EXAMPLES

### Example 1

### Application to a Mixture of Hydrocarbons According to the 80.45EPACM Model

The emission properties Rⱼε{N, V, T}, with N emissions of NOₓ, V the emissions of volatile organic compounds and T the toxic emissions, are considered for a mixture M of hydrocarbons.

A target gasoline, with vector of properties x, is manufactured from a set of base products (the bases or constituents) characterized by their properties B₁, . . . , BₙεR^{P}, where P is the number of properties of the gasoline. Among the properties of the target gasoline may be cited:

OXY: the oxygen content (% by mass)

SUL: the sulfur content (ppm by mass)

RVP: the vapor pressure (Reid procedure) or Reid vapor pressure (in PSI),

E200: the distillation fraction at 200° F. (% by volume),

E300: the distillation fraction at 300° F. (% by volume),

ARO: the aromatics content (% by volume)

BEN: the benzene content (% by volume)

OLE: the olefins content (% by volume)

MTB: the methyl ethylbenzene content (% by volume of oxygen)

ETB: the ethyl terbutyl ether content (% by volume of oxygen),

TAM the tertioamylathylether content (% by volume of oxygen)

ETH: the ethanol content (% by volume of oxygen).

Other properties can be calculated and monitored for the gasolines but the above list gives the properties which come into the calculation of NOx(x), VOC(x) and TOX(x) of the 80.45EPACM model.

A recipe is a vector uεRⁿ, such that uᵢ, i=1, . . . , n, indicates the percentage of the volume of the base Bᵢ in the mixture x. The properties of x are a function of the characteristics of the bases B=[B₁, . . . , Bₙ] and of the recipe u, x=x(B, u). In a sufficiently short temporary horizon (this being the case of application of the example) it may be considered that B is constant and only u is variable for monitoring.

For a mixture M, it is considered that the hydraulic and operative constraints impose minimum constraints u and maximum constraints ū on the recipes, expressed through the inequality:

u≦u≦ū (18)

Furthermore, minimum constraints c and maximum constraints c̅ on the properties are imposed by 80.45EPACM in order for a mixture to be compliant. They are expressed by the following inequality:

c≦x=x(u)≦c̅ (19)

Note that when the gasoline x does not satisfy the constraints or is not optimal for a given recipe u*, it is then possible to modify it by following an optimization of a function of the form:

F(u)=a·∥u−u°∥+b·∥x(u)−x°∥ (20)

where u° is a reference recipe predefined by the user and x° an “ideal” target gasoline which minimizes the over-quality. This can be implemented during step (26) described with reference to FIG. 2.

The calculation of the emissions involves an additional phase. Depending on the season (Summer, Winter), the region (1, 2) and the type of gasoline (reformulated: RFG or conventional: CFG) the characteristics of the reference gasoline, denoted xb subsequently, and the min/max bounds on the mixture x in table 1 hereinbelow are chosen (note that the reference gasoline denoted xb in the present patent application is denoted b in 80.45EPACM).

Moreover, in table 1, the value of OXY is OXY=ETB+MTB+ETH+TAM.

The values given in table 1 correspond to the values c, c̅ of the inequalities (14) and (19) of the summary of the invention.

TABLE 1
Reference gasoline and min/max ranges for 80.45EPACM.

| | xb | xb | RFG | | CFG | |
|---|---|---|---|---|---|---|
| | Summer | Winter | Min | Max | Min | Max |
| OXY | 0.0 | 0.0 | 0.0 | 4.0 | 0.0 | 4.0 |
| SUL | 339 | 338 | 0.0 | 500.0 | 0.0 | 1000.0 |
| RVP | 8.7 | 11.5 | 6.4 | 10.0 | 6.4 | 11.0 |
| E200 | 41.0 | 50.0 | 30.0 | 70.0 | 30.0 | 70.0 |
| E300 | 83.0 | 83.0 | 70.0 | 100.0 | 70.0 | 100.0 |
| ARO | 32.0 | 26.4 | 0.0 | 50.0 | 0.0 | 55.0 |
| OLE | 9.2 | 11.9 | 0.0 | 25.0 | 0.0 | 30.0 |
| BEN | 1.53 | 1.64 | 0.0 | 2.0 | 0.0 | 4.9 |

The estimation of the emissions N, V, T in 80.45EPACM furthermore uses coefficients for Normal or High Emitters presented in table 2:

TABLE 2
Coefficients according to emitters and emissions.

| | VOC + TOX | NOₓ |
|---|---|---|
| Normal Emitters (w_{N}) | 0.444 | 0.738 |
| Higher Emitters (w_{H}) | 0.556 | 0.262 |

Table 3 hereinbelow finally provides the reference emissions according to season and region. The values of this table serve as hard bounds not to be exceeded by the emissions of the current gasoline x(u). For example, in summer, for region 2, we must have:

NOx(u)≦1340.0; VOC(u)≦1399.1; TOX(u)≦85.61 (21)

TABLE 3
Reference emissions.

| | |
|---|---|
| Summer | Winter |

| | Region 1 | Region 2 | Region 1 | Region 2 |
|---|---|---|---|---|
| NOX | 1340.0 | 1340.0 | 1540.0 | 1540.0 |
| VOC | 1466.3 | 1399.1 | 1341.0 | 1341.0 |
| TOXICS | 86.34 | 85.61 | 120.55 | 120.55 |

By way of example, in 80.45EPACM, the function NOx(u) (see FIG. 3B) is dependent on the properties x: OXY, SUL, RVP, E200, E300, ARO, OLE of the mixture. Depending on the season or depending on the ranges of the values of E300, SUL, OLE, ARO (see table 4 hereinbelow) two vectors are generated: y and z.

The vector y, called “edge target”, is a vector of properties of a gasoline whose properties are fixed by the 80.45EPACM model and by the conditions of the “IF-List” (see below).

The vector z, called “delta target”, is a vector expressing the difference between the vector y hereinabove and the vector x of the properties of the mixture of the recipe in progress.

These vectors y and z take particular values as a function of the bounds of table 4. They must thus comply with a list of disjunctive conditions, called an “IF-list”, given in table 5.

Note that with respect to the notation of 80.45EPACM, the values of y correspond to the values of 80.45EPACM with the index “et” (for example E300et=y(E300)). The values of z “delta target” correspond to the values ΔARO, ΔE300, etc. of the 80.45EPACM (for example ΔARO=z(ARO)).

TABLE 4

| Property xₖ of | Min Bound | Max Bound |
|---|---|---|
| the mixture | (mₖ) | (Mₖ) |
| SUL | 10.0 | 450.0 |
| OLE | 3.77 | 19.0 |
| ARO | 18.0 | 36.8 |

TABLE 5
Disjunctive conditions in winter for NOx(u)
“IF - List”

If Season = Winter then, y(RVP) = 8.7.
If x(E300) > 95 then y(E300) = 95.
If x(SUL) < 10 then y(SUL) = 10, z(SUL) = x(SUL) − 10.
If x(SUL) > 450 then y(SUL) = 450, z(SUL) = x(SUL) − 450.
If x(OLE) < 3.77 then y(OLE) = 3.77, z(OLE) = x(OLE) − 3.77.
If x(OLE) > 19 then y(OLE) = 19, z(OLE) = x(OLE) − 19.
If x(ARO) < 10 then y(ARO) = 10, z(ARO) = −8.
If x(ARO) < 18 then y(ARO) = 18, z(ARO) = x(ARO) − 18.
If x(ARO) > 36.8 then y(ARO) = 36.8, z(ARO) = x(ARO) − 36.8.

Similarly, in 80.45EPACM, the functions VOC(u) and TOX(u) depend on a series of predetermined properties of the mixture.

The function VOX(u) is expressed as a function of y(x(u)), b(x(u)), z(x(u)), (see FIG. 3A), where the functions y and z are those defined above and where the function b(x(u)) is a vector of the properties of a reference gasoline provided by 80.45EPACM.

The function TOX(u) is expressed as a function solely of the vector y (see FIG. 3C).

Note that particular IF-Lists similar to those presented in table 5 are fixed for the various pollutants NOx(u), VOC(u) and TOX(u).

FIG. 3 schematically represents the steps of calculating the functions NOx(u), VOC(u) and TOX(u) as well as the functions entering into their determination.

In particular:
FIG. 3(A) represents the steps of calculating the emission property R=V=VOX(u),
FIG. 3(B) represents the steps of calculating the emission property R=N=NOX(u),
FIG. 3(C) represents the steps of calculating the emission property R=T=TOX(u).

The conditions expressed in the IF-list of table 5 for the determination of the function NOx(u) can generally be written in the following manner for a property xₖ:

if xₖ<mₖ, then yₖ=mₖ and zₖ=xₖ−mₖ (3)

if xₖ≧mₖ AND xₖ≦Mₖ, then yₖ=xₖ and z=0 (4)

if xₖ>Mₖ, then yₖ=Mₖ and zₖ=xₖ−Mₖ (5)

the bounds mₖ, Mₖ, taking the values indicated in table 4.

According to the invention, y and z are expressed as a function of a sign function so as to integrate these disjunctive conditions (3), (4) (5) into y and z by formulating them in the form of the following functions already defined:

y(xₖ)=(1−S(xₖ,mₖ))·m+S(xₖ,mₖ)·(1−S(xₖ,Mₖ))·x+S(xₖ,Mₖ)·Mₖ (6)

z(xₖ)=(1−S(xₖ,mₖ))·(xₖ−mₖ)+S(xₖ,Mₖ)·(xₖ−Mₖ) (7)

Let y and z be thus reformulated according to (6) and (7) respectively, the calculation of NOx(u) then involves intermediate calculation steps described hereinbelow.

Note that in the formulae which follow, the indicated property (OXY, SUL, etc.) pertains to the input variable of the formula (y or z).

1st Step

$${n}_{1} ( y ) = ( 0.0018571 \cdot OXY ) + ( 0.0006921 \cdot SUL ) + ( 0.0090744 \cdot RVP ) + ( 0.0009310 \cdot E 200 ) + ( 0.0008460 \cdot E 300 ) + ( 0.0083632 \cdot ARO ) + ( - 0.002774 \cdot OLE ) + ( - 6.63 \cdot {10}^{- 7} \cdot {SUL}^{2} ) + ( - 0.000119 \cdot {ARO}^{2} ) + ( 0.0003665 \cdot {OLE}^{2} )$$

$${n}_{2} ( y ) = ( - 0.00913 \cdot OXY ) + ( 0.000252 \cdot SUL ) + ( - 0.01397 \cdot RVP ) + ( 0.000931 \cdot E 200 ) + ( - 0.00401 \cdot E 300 ) + ( 0.007097 \cdot ARO ) + ( - 0.00276 \cdot OLE ) + ( 0.0003665 \cdot {OLE}^{2} ) + ( - 7.995 \cdot {10}^{- 5} \cdot {ARO}^{2} )$$

n₁(xb) and n₂(xb) are also calculated.

Thereafter N(y)=eⁿ^{ᵢ}^{(y)-n}^{₁}^{(xb)} and H(y)=eⁿ^{₂}^{(y)-n}^{₂}^{(xb)} are calculated.

$$FN ( y , z ) = 1 + z ( SUL ) \cdot ( - 0.00000133 \cdot y ( SUL ) + 0.000692 ) + z ( ARO ) \cdot ( - 0.000238 \cdot y ( ARO ) + 0.0083632 ) + z ( OLE ) \cdot ( 0.000733 \cdot y ( OLE ) - 0.002774 )$$

$$FH ( y , z ) = 1 + 0.000252 \cdot z ( SUL ) + z ( ARO ) \cdot ( - 0.0001599 \cdot y ( ARO ) + 0.007097 ) + z ( OLE ) \cdot ( 0.000732 \cdot y ( OLE ) - 0.00276 )$$

2nd Step

The coefficients w_{N} and W_{H} of Table 2 are chosen and NOx(u) is calculated:

$$\begin{matrix}NOx ( u ) = NOx ( x ( u ) ) \\ = NOx ( y , z ) \\ = {w}_{N} \cdot N ( y ) \cdot FN ( y , z ) + {w}_{H} \cdot H ( y ) \cdot FH ( y , z )\end{matrix} \qquad ( 22 )$$

The calculations of these two steps are merely functions compounded with y and z. Thus, there will be no need for additional constraints in order to verify whether y and z have been calculated correctly, while complying with the disjunctive conditions of the IF-List. The introduction of the numerous binary variables and mixed constraints which increase the complexity of the problem is thus avoided. We point out that the use of the function S(x, r) does not modify the properties of NOx(u) (nor of the other emissions).

By replacing in the formulations of y and z the function S(xₖ, r) by the sigmoid function SC(xₖ, r):

SC(xₖ,r,a)=0.5(1+tan h(a·(xₖ−r)) (8)

NOx(u) can then be written in the form of a differentiable continuous function.

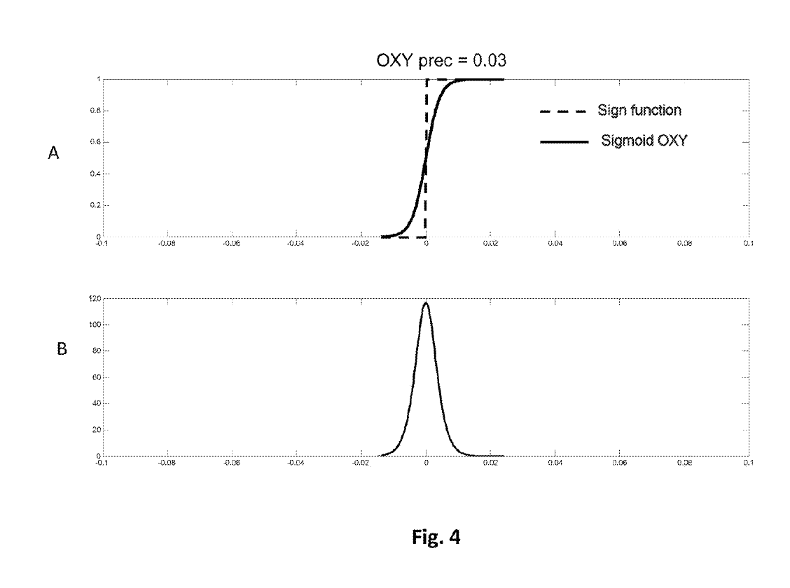

FIG. 4 represents the Function SC(t, r, a) (A) and its first derivative (B) for the property OXY. In FIG. 4A, the sign function is also represented. Note that the coefficient a corresponds to the derivative SC′(t, r, a) of the function SC(t, r, a) at the point t=r. This coefficient can be chosen so that the function SC(t, r, a) is equal to S(t, r) except in a small interval t ε]r−δ,r+δ[. Knowing the precision of measurement of each property, it is easy to choose a such that 2δ is less than the measurement error. In the example of FIG. 4A, the precision of the measurement is 2δ=0.03. Thus, the values of the emissions calculated using (8) will be the same as those calculated with the sign function (1) to within the error in measuring the properties.

NOx being written in the form of a differentiable function, it is henceforth possible to calculate the gradient of NOx with respect to the properties of the gasoline x and with respect to the recipe u. The calculation of the Hessian of NOx is also henceforth possible. The gradient and the Hessian will in particular be able to be used in the monitoring method, in particular at the level of steps (23) and (26) described with reference to the logic diagram of FIG. 2.

The calculation of the gradient is detailed hereinafter by way of example. The Hessian will be able to be calculated in a similar manner.

### Example 2

### Gradient Calculation

$$\frac{\partial NOx ( u )}{\partial {u}_{k}} = {\sum }_{j = 1}^{p} \frac{\partial NOx ( x )}{\partial {x}_{j}} \cdot \frac{\partial {x}_{j}}{\partial {u}_{k}} , \\ k = 1 , … , n$$

It will be necessary to calculate the derivative

$$\frac{\partial {x}_{j}}{\partial {u}_{k}}$$

for any property xⱼ as a function of u. For linear mixing laws this is simply the coefficient of the matrix of the bases B(j, k). Recall that we have calculated y and z from x. Consequently:

$$\frac{\partial NOx ( x )}{\partial {x}_{k}} = {\sum }_{j = 1}^{p} ( \frac{\partial NOx ( y , z )}{\partial {y}_{j}} \cdot \frac{\partial {y}_{j}}{\partial {x}_{k}} + \frac{\partial NOx ( y , z )}{\partial {z}_{j}} \cdot \frac{\partial {z}_{j}}{\partial {x}_{k}} )$$

where p is the number of properties of the gasoline.

We now arrive at the level of the calculations of each term of NOx of formula (22).

$$\frac{\partial NOx ( y , z )}{\partial {y}_{j}} = {w}_{N} \cdot ( \frac{\partial N ( y )}{\partial {y}_{j}} \cdot FN ( y , z ) + \frac{\partial FN ( y , z )}{\partial {y}_{j}} \cdot N ( y ) ) + {w}_{H} \cdot ( \frac{\partial H ( y )}{\partial {y}_{j}} \cdot FH ( y , z ) + \frac{\partial FH ( y , z )}{\partial {y}_{j}} \cdot H ( y ) )$$

Given the exponential form of N(y) and H(y) we have:

$$\frac{\partial NOx ( y , z )}{\partial {y}_{j}} = {w}_{N} \cdot N ( y ) \cdot ( \frac{\partial {n}_{1} ( y )}{\partial {y}_{j}} \cdot FN ( y , z ) + \frac{\partial FN ( y , z )}{\partial {y}_{j}} ) + {w}_{H} \cdot H ( y ) \cdot ( \frac{\partial {n}_{2} ( y )}{\partial {y}_{j}} \cdot FH ( y , z ) + \frac{\partial FH ( y , z )}{\partial {y}_{j}} )$$

$$\frac{\partial NOx ( y , z )}{\partial {z}_{j}} = {w}_{N} \cdot \frac{\partial FN ( y , z )}{\partial {z}_{j}} \cdot N ( y ) + {w}_{H} \cdot \frac{\partial FH ( y , z )}{\partial {z}_{j}} \cdot H ( y )$$

We note in turn the values of y and z on running through the properties of the gasoline.

y=y(OXY),z=z(OXY). We have:

$$\frac{\partial {n}_{1} ( y )}{\partial y} = 0.0018571 ;$$

$$\frac{\partial {n}_{2} ( y )}{\partial y} = - 0.00913 ;$$

$$\frac{\partial FN ( y , z )}{\partial y} = \frac{\partial FH ( y , z )}{\partial y} = \frac{\partial FH ( y , z )}{\partial z} = \frac{\partial FH ( y , z )}{\partial z} = 0 ;$$

y=y(SU L), z=z(SUL). We have:

$$\frac{\partial {n}_{1} ( y )}{\partial y} = 0.00069205 - 2 \cdot 6.6263 \cdot {10}^{- 7} \cdot y ;$$

$$\frac{\partial {n}_{2} ( y )}{\partial y} = 0.000252 ;$$

$$\frac{\partial FN ( y , z )}{\partial y} = z \cdot ( - 0.00000133 ) ;$$

$$\frac{\partial FH ( y , z )}{\partial y} = 0 ;$$

$$\frac{\partial FH ( y , z )}{\partial z} = ( - 0.00000133 \cdot y + 0.000692 ) ;$$

$$\frac{\partial FH ( y , z )}{\partial z} = 0.000252 ;$$

y=y(RVP), z=z(RVP). We have:

$$\frac{\partial {n}_{1} ( y )}{\partial y} = 0.0090744 ;$$

$$\frac{\partial {n}_{2} ( y )}{\partial y} = - 0.013973 ;$$

$$\frac{\partial FN ( y , z )}{\partial y} = \frac{\partial FH ( y , z )}{\partial y} = \frac{\partial FH ( y , z )}{\partial z} = \frac{\partial FH ( y , z )}{\partial z} = 0 ;$$

y=y(E200),z=z(E200). We have:

$$\frac{\partial {n}_{1} ( y )}{\partial y} = 0.00093065 ;$$

$$\frac{\partial {n}_{2} ( y )}{\partial y} = 0.000931 ;$$

$$\frac{\partial Fn ( y , z )}{\partial y} = \frac{\partial Fh ( y , z )}{\partial y} = \frac{\partial Fn ( y , z )}{\partial z} = \frac{\partial Fh ( y , z )}{\partial z} = 0 ;$$

y=y(E300),z=z(E300). We have:

$$\frac{\partial {n}_{1} ( y )}{\partial y} = 0.00084596 ;$$

$$\frac{\partial {n}_{2} ( y )}{\partial y} = - 0.004009 ;$$

$$\frac{\partial Fn ( y , z )}{\partial y} = \frac{\partial Fh ( y , z )}{\partial y} = \frac{\partial Fn ( y , z )}{\partial z} = \frac{\partial Fh ( y , z )}{\partial z} = 0 ;$$

y=y(ARO), z=z(ARO). We have:

$$\frac{\partial {n}_{1} ( y )}{\partial y} = 0.0083632 - 2 \cdot 0.00011905 \cdot y ;$$

$$\frac{\partial {n}_{2} ( y )}{\partial y} = 0.007097005 - 2 \cdot 0.000079951 \cdot y ;$$

$$\frac{\partial FN ( y , z )}{\partial y} = z \cdot ( - 0.000238 ) ;$$

$$\frac{\partial FN ( y , z )}{\partial y} = z \cdot ( - 0.0001599 ) ;$$

$$\frac{\partial FH ( y , z )}{\partial z} = ( - 0.000238 \cdot y + 0.0083632 ) ;$$

$$\frac{\partial FH ( y , z )}{\partial z} = - 0.0001599 \cdot y + 0.007097 ;$$

y=y(OLE),z=z(OLE). We have:

$$\frac{\partial {n}_{1} ( y )}{\partial y} = - 0.0027735 + 2 \cdot 0.00036652 \cdot y ;$$

$$\frac{\partial {n}_{2} ( y )}{\partial y} = - 0.0027603 + 2 \cdot 0.000366 \cdot y ;$$

$$\frac{\partial FN ( y , z )}{\partial y} = z \cdot ( 0.000733 ) ;$$

$$\frac{\partial FN ( y , z )}{\partial y} = z \cdot ( 0.000732 ) ;$$

$$\frac{\partial FH ( y , z )}{\partial z} = 0.000733 \cdot y - 0.002774 ;$$

$$\frac{\partial FH ( y , z )}{\partial z} = 0.000732 \cdot y - 0.00276 ;$$

For any property p different from SUL, OLE and ARO, we have y(p)=x(p) and z(p)=0. For these properties, ∂y(p)/∂x(p)=1 and ∂z(p)/∂x(p)=0. For SUL, OLE and ARO the calculation of these derivatives involves the derivative of the function SC(t, r, a). For each of these properties, the following will be taken, for the IF list of Table 5:
p=SUL,m=10,M=450,a=a(SUL)
p=OLE,m=3.77,M=19,a=a(OLE)
p=ARO,m=18,M=36.8,a=a(ARO)

and the following will be calculated:

$$\frac{\partial {y}_{p}}{\partial {x}_{p}} = - m \cdot {SC}^{′} ( {x}_{p} , m , a ) + M \cdot {SC}^{′} ( {x}_{p} , M , a ) + {SC}^{′} ( {x}_{p} , m , a ) \cdot ( 1 - SC ( {x}_{p} , M ) ) \cdot {x}_{p} - SC ( {x}_{p} , m ) \cdot {SC}^{′} ( {x}_{p} , M , a ) \cdot {x}_{p} + S ( {x}_{p} , m ) \cdot ( 1 - SC ( {x}_{p} , M ) )$$

$$\frac{\partial {z}_{p}}{\partial {x}_{p}} = - ( {x}_{p} - m ) \cdot {SC}^{′} ( {x}_{p} , m , a ) + ( 1 - SC ( {x}_{p} , m ) ) + SC ( {x}_{2} , M ) + ( {x}_{p} - M ) \cdot {SC}^{′} ( {x}_{p} , M , a )$$

The calculation of the gradient of each emission with respect to the properties x and especially with respect to the recipe u opens the path for on-line monitoring of the emissions as is already the case for the conventional properties of gasolines.

### Example 3

### Numerical Calculation of NOx(u) and of its Gradient

The function NOx(u) is dependent on the properties OXY, SUL, RVP, E200, E300, ARO, OLE.

We consider zone C, phase 2, season summer, of the 80.45EPACM model.

In this example, we consider the situation at the point x(u) whose values are given in Table 6, and we vary only the value of E300. The function NOx(x) exhibits a break in slope for the values of the property E300>95 due to the conditions of the IF-List for the period concerned. The precision in this property E300 is: Prec(E300)=0.4.

Table 7 presents the results of the comparison between the values of the function NOx(x), for various values of E300:
when the function NOₓ(x) is not regularized (stated otherwise the function used is the 80.45EPACM model function rewritten using the sign function S(xₖ, r)),
when the function NOₓ(x) is regularized (stated otherwise, the function is the 80.45EPACM model function rewritten using the sigmoid function SC(xₖ, r)), by considering a coefficient a associated with the sigmoid function of the property E300 such that a=Prec (E300)/7,
when the function NOₓ(x) is regularized by considering a coefficient a associated with the sigmoid function of the property E300 such that a=Prec (E300)/14,

TABLE 6

| | | x(u) | Prec(y) |
|---|---|---|---|
| SULF | ppm | 9 | 0.5 |
| RVP | psi | 8.2 | 0.7 |
| E200 | % | 50 | 0.8 |
| E300 | % | 95 | 0.4 |
| ARO | Vol % | 30 | 0.5 |
| OLE | Vol % | 3 | 0.4 |
| BENZ | Vol % | 0.42 | 0.01 |
| MTBE | % weight oxygen | 0 | 0.03 |
| ETBE | % weight oxygen | 3.42 | 0.03 |
| ETHANOL | % weight oxygen | 0 | 0.03 |
| TAME | % weight oxygen | 0 | 0.03 |

TABLE 7

| | NOₓ(x) | NOₓ(x) Regularized | NOₓ(x) Regularized |
|---|---|---|---|
| E300 | Non-regularized | a = Prec(E300)/7 | a = Prec(E300)/14 |
| 95 | 1154.2474834232 | 1154.2474834232 | 1154.2474834232 |
| 95.1 | 1154.2474834232 | 1154.2460974777 | 1154.2474403460 |
| 95.2 | 1154.2474834232 | 1154.2473972689 | 1154.2474833445 |
| 95.3 | 1154.2474834232 | 1154.2474795173 | 1154.2474834231 |
| 95.4 | 1154.2474834232 | 1154.2474832659 | 1154.2474834232 |
| 95.5 | 1154.2474834232 | 1154.2474834172 | 1154.2474834232 |
| 95.6 | 1154.2474834232 | 1154.2474834230 | 1154.2474834232 |
| 95.7 | 1154.2474834232 | 1154.2474834232 | 1154.2474834232 |
| 95.8 | 1154.2474834232 | 1154.2474834232 | 1154.2474834232 |

It is thus noted that the values NOₓ(x) calculated by modifying the function NOₓ of the 80.45EPACM model according to the invention by formulating the IF list in continuous and differentiable function form by means of a sigmoid function makes it possible to obtain results very close to those obtained with the function of the 80.45EPACM model. It is also noted that the more one reduces the value of the coefficient a, the faster one converges to the non-regularized value.

We now compare the gradients of NOₓ(x). Table 8 indicates the values of the numerical gradients of the non-regularized function NOₓ(x), to the left and to the right of E300=95.

TABLE 8

| δ | (Nox(x + δ) − Nox(x − δ))/(2δ) |
|---|---|
| 0.1 | −0.236550013 |
| 0.0001 | −0.2364145 |
| 0.00000001 | −0.235002063 |

The analytical gradient of the property E300, calculated using the formulations according to the invention of the gradient, developed in example 2, is then: −0.23641474. The derivative to the right always gives 0 since the value of E300>95 is referred back to 95. The numerical estimation of the derivative is done through a symmetric formula (see column 2 of table 8). It is observed that the numerical and analytical gradients are very close in this case.

1. A method for monitoring the properties of a mixture M of n solid, liquid or gaseous constituents, said mixture exhibiting:
properties x(B, u) where x(u)=[x₁, . . . xₖ] is a vector of k properties of the mixture M, k a non-zero positive integer,
u=[u₁, . . . uₙ] is a recipe vector and uᵢ, i=1, . . . , n, indicates the proportion of the ith constituent in the mixture M,
B=[B₁, . . . , Bₙ] is a matrix of the properties of the n constituents,
at least one property R(u)=R(y(x(u)), z(x(u))) induced by the properties x(B, u), where z(x(u))=y(x(u))−x(u)
y(x(u)) is a vector of properties of the mixture
and where y(x(u)) and z(x(u)) are such that they comply with disjunctive conditions which, for each property xₖ, allocate to yₖ at least one value chosen from among xₖ, mₖ, Mₖ, as a function of one or more inequalities between said value xₖ and at least one value mₖ, Mₖ, where mₖ, Mₖ are predefined constants and xₖ is the value of the property k for a recipe u,
characterized in that said method comprises the following steps:
(A) the properties x(u) of the mixture M are determined,
(B) the at least one induced property R(u) of the mixture M is estimated, R(u) being dependent:
on a set of predetermined properties x(u) of the mixture
on the functions y(x(u)) and z(x(u)) associated with these predetermined properties, said functions being formulated so that, for each property xₖ considered, y(xₖ) and z(xₖ) are functions of S(xₖ, r) where:
$$\begin{matrix}S ( {x}_{k} , r ) = 0.5 \cdot ( 1 + sign ( {x}_{k} - r ) ) & ( 1 ) \\ sign ( {x}_{k} - r ) = \{ \begin{matrix}- 1 {x}_{k} \leq r \\ 1 {x}_{k} > r\end{matrix} & ( 2 )\end{matrix}$$
r being equal to mₖ or Mₖ,
(C) a recipe u is determined so that at least one previously estimated induced property Rⱼ, j=1, . . . , q (with q a non-zero positive integer) of said mixture M obtained complies with specifications Rⱼ≦Rⱼ(u) and/or Rⱼ(u)≦R̅ⱼ, Rⱼ, R̅ⱼ̅ being minimum and maximum admissible values, respectively, of said induced property Rⱼ,
(D) at least one signal for control of means for distributing the constituents of the mixture M is generated as a function of the determined recipe u,
(E) said at least one control signal is transmitted to the means for distributing the constituents so as to obtain a mixture M.

2. The monitoring method as claimed in claim 1, in which, in the estimation of said induced property R(u), the function S(xₖ, r) is approximated by a sigmoid function SC(xₖ, r):
SC(xₖ,r,a)=0.5·(1+tan h(a·(xₖ−r)) (8)
with a, predetermined coefficient for the property xₖ corresponding to the slope of the curve SC(xₖ, r) when xₖ=r.

3. The monitoring method as claimed in claim 2, in which the coefficient a is chosen so that SC(xₖ, r)=S(xₖ, r) except over an interval r−δ<xₖ<r+δ where δ is chosen so that 2δ is less than an error in determining the property xₖ.

4. The monitoring method as claimed in claim 2, in which the coefficient a is less than or equal to δ.

5. The monitoring method as claimed in claim 1, in which it is considered:
that a mixture M of recipe u complies with a specification Rⱼ(u)≦R̅ⱼ̅ if and only if:
F(u)=Σ_{R}_{ⱼ}_{ε{R}_{₁}_{, . . . ,R}_{ₚ}_{}}[Rⱼ>R̅ⱼ̅]·(Rⱼ(u)−R̅ⱼ̅)=0 (9)
that a mixture M of recipe u complies with a specification Rⱼ≦Rⱼ(u) if and only if
F(u)=Σ_{R}_{ⱼ}_{ε{R}_{₁}_{, . . . ,R}_{ₚ}_{}}[Rⱼ<Rⱼ]·(Rⱼ−Rⱼ(u))=0 (9′)
that a mixture M of recipe u complies with a specification Rⱼ(u)≦R̅ⱼ̅ and Rⱼ(u)≧Rⱼ, if and only if:
F(u)=Σ_{R}_{ⱼ}_{ε{R}_{₁}_{, . . . ,R}_{_{P}}_{}}(·[Rⱼ>R̅ⱼ̅]·(Rⱼ(u)−R̅ⱼ̅)+·[Rⱼ<Rⱼ]·(Rⱼ(u)−Rⱼ))=0 (9″)
where:
[Rⱼ>R̅ⱼ]=1 if Rⱼ>R̅ⱼ̅ and [Rⱼ>R̅ⱼ]=0 otherwise
[Rⱼ<Rⱼ]=1 if Rⱼ<Rⱼ and [Rⱼ<R̅ⱼ]=0 otherwise.

6. The monitoring method as claimed in claim 5, in which it is considered that a mixture M of recipe u complies with the specifications Rⱼ(u)≦R̅ⱼ̅ and/or Rⱼ≦Rⱼ(u) if and only if:
$$\begin{matrix} F ( u , π ) = {\sum }_{{R}_{j} ∈ \{ {R}_{1} , … , {R}_{p} \}} {\overline{π}}_{{R}_{j}} \cdot [ {R}_{j} > {\overline{R}}_{j} ] \cdot ( {R}_{j} ( u ) - {\overline{R}}_{j} ) = 0 \\ or & ( 10 ) \\ F ( u , π ) = {\sum }_{{R}_{j} ∈ \{ {R}_{1} , … , {R}_{p} \}} {\overline{π}}_{{R}_{j}} \cdot [ {R}_{j} < {\underline{R}}_{j} ] \cdot ( {\underline{R}}_{j} - {R}_{j} ( u ) ) = 0 \\ or & ( {10}^{′} ) \\ F ( u , π ) = {\sum }_{{R}_{j} ∈ \{ {R}_{1} , … , {R}_{p} \}} ( {\overline{π}}_{{R}_{j}} \cdot [ {R}_{j} > \overline{{R}_{j}} ] \cdot ( {R}_{j} ( u ) - \overline{{R}_{j}} ) + {\underline{π}}_{{R}_{j}} \cdot [ {R}_{j} < {\underline{R}}_{j} ] \cdot ( {R}_{j} ( u ) - {\underline{R}}_{j} ) ) = 0 & ( {10}^{′′} )\end{matrix}$$
where π̅_{R}_{ⱼ}, π_{R}_{ⱼ} are parameters representative of a penalization associated with the property Rⱼ when said property does not comply with the specification Rⱼ(u)≦R̅ⱼ̅, Rⱼ≦Rⱼ(u), respectively.

7. The monitoring method as claimed in claim 5, in which [Rⱼ>R̅ⱼ̅] is approximated by a sigmoid function SC(Rⱼ, R̅ⱼ̅), respectively SC(Rⱼ, Rⱼ):
SC(Rⱼ,R̅ⱼ,a)=0.5(1+tan h(a(Rⱼ−R̅ⱼ̅))) (11)
with a predetermined coefficient for the property Rⱼ corresponding to the slope of the curve SC(Rⱼ, R̅ⱼ̅) when Rⱼ=R̅ⱼ̅,
and/or
[Rⱼ<Rⱼ] is approximated by a sigmoid function SC(Rⱼ,Rⱼ):
SC(R₁,Rⱼ,a′)=0.5(1+tan h(a′(Rⱼ−Rⱼ))) (11′)
with a′ predetermined coefficient for the emission property Rⱼ corresponding to the slope of the curve SC(Rⱼ, Rⱼ) when Rⱼ=Rⱼ.

8. The monitoring method as claimed in claim 2, which comprises a step of optimizing the recipe u in the course of which a solution is sought to an optimization problem taking into account a group of constraints on the recipes u, a group of constraints on the properties x and a group of constraints on the induced properties Rⱼ, said optimization problem being defined by:
$$\{ \begin{matrix}min F ( u ) ( or min F ( u , π ) ) \\ {\underline{u}}_{IU} \leq u \leq {\overline{u}}_{IU} \\ \underline{p} ( {L}_{P} ) \leq x ( {L}_{P} ) , x ( {U}_{P} ) \leq \overline{p} ( {U}_{P} )\end{matrix} \qquad ( 12 )$$
where
F(u) is such as defined in claim 5 or 7, F(u, π) is such as defined in claim 6 or 7;
u_{IU}≦u≦ū_{IU}(13) represents the constraints on the recipes, with u_{IU} and Ū_{IU}, minimum and maximum values respectively of a recipe u for a whole group of constraints IU,
p(L_{P})≦x(L_{P}),x(U_{P})≦p̅(U_{P}) (14) represents the constraints on the properties x of the mixture, with p(L_{P}) and p̅(U_{P}) minimum and maximum values respectively of a property x for a whole group of constraints L_{P}, U_{P}⊂̅{1, . . . , P}, where P: number of properties tracked,
said optimization step using, for the search for a solution u₀ to the optimization problem (12), the value of the function F(u₀) and the value of its derivative, or the value of the function F(u₀, π) and the value of its derivative, said derivative value being determined by expressing said derivative on the basis of the estimation of said induced property R(u) in which the function S(xₖ, r) is approximated by the sigmoid function SC(xₖ, r) (8) such as defined according to claim 2, said value of the function F(u₀) or F(u₀, π) being determined on the basis of said estimation of said induced property R(u) in which the function S(xₖ, r) is optionally approximated by the sigmoid function SC(xₖ, r) (8) such as defined according to claim 2, said problem (12) being solvable when there exists an optimal solution u₀ for which F(u₀)=0 or F(u₀, π)=0.

9. The monitoring method as claimed in claim 8, comprising
(a) a step of defining an instance of mixture in which there is defined:
a matrix B of the properties of the n constituents,
a set IU of constraints on the recipes u such that u_{IU}≦u≦ū_{IU}, with u_{IU}, ū_{IU} minimum, respectively maximum, values of said set IU
a set L_{P}, U_{P} ⊂̅{1, . . . , P}, where P: number of properties tracked, of minimum values L_{P} and maximum values U_{P} of the properties x,
optionally a penalty vector π̅_{R}_{ⱼ} and/or π_{R}_{ⱼ} for a property R,
(b) optionally, a step of searching for feasible mixtures, in the course of which, for Rⱼε{R₁, . . . , R_{P}}, we solve
$$\begin{matrix}\{ \begin{matrix}max {R}_{j} ( u ) \\ {\underline{u}}_{IU} \leq u \leq {\overline{u}}_{IU} \\ \underline{p} ( {L}_{P} ) \leq x ( {L}_{P} ) , x ( {U}_{P} ) \leq \overline{p} ( {U}_{P} )\end{matrix} \\ and \text{/} or & ( 16 ) \\ \{ \begin{matrix}min {R}_{j} ( u ) \\ {\underline{u}}_{IU} \leq u \leq {\overline{u}}_{IU} \\ \underline{p} ( {L}_{P} ) \leq x ( {L}_{P} ) , x ( {U}_{P} ) \leq \overline{p} ( {U}_{P} )\end{matrix} & ( {16}^{′} )\end{matrix}$$
in which the value of the function R(u) and the value of its derivative are used for the search for a solution u to the optimization problem (16, 16′), said derivative value being determined by expressing said derivative on the basis of the estimation of said induced property R(u) in which the function S(xₖ, r) is approximated by the sigmoid function SC(xₖ, r) (8) such as defined according to claim 2, said value of the function R(u) being determined on the basis of said estimation of said induced property R(u) in which the function S(xₖ, r) is optionally approximated by the sigmoid function SC(xₖ, r) (8) such as defined according to claim 2,
(c) an optimization step such as defined in claim 8, in the course of which an optimal solution u₀ is sought to the optimization problem:
$$\{ \begin{matrix}min F ( u ) or min F ( u , π ) \\ {\underline{u}}_{IU} \leq u \leq {\overline{u}}_{IU} \\ \underline{p} ( {L}_{P} ) \leq x ( {L}_{P} ) , x ( {U}_{P} ) \leq \overline{p} ( {U}_{P} )\end{matrix} \qquad ( 12 )$$
and if F(u₀)>0 or F(u₀, π)>0, the previous steps are repeated while modifying the sets of constraints and/or the constituents of the step of defining an instance of mixture.

10. The method as claimed in claim 9, in which, if in step (c) F(u₀)=0 or F(u₀, π)=0, the method comprises a step (d) in which:
at least one value Fᵢ(u₀) is calculated where Fᵢ is a function taking into account an additional constraint,
an optimal solution (S*,T*, u*) of a second optimization problem is found
$$\{ \begin{matrix}min G ( S , T , u ) = a \cdot S + b \cdot T + w \cdot F ( u , π ) \\ {F}_{1} ( u ) \leq S \cdot {F}_{1} ( {u}_{0} ) \\ {F}_{2} ( u ) \leq T \cdot {F}_{2} ( {u}_{0} ) \\ 0 < S , T \leq 1 \\ {\underline{u}}_{IU} \leq u \leq {\overline{u}}_{IU} \\ \underline{p} ( {L}_{P} ) \leq x ( {L}_{P} ) , x ( {U}_{P} ) \leq \overline{p} ( {U}_{P} )\end{matrix} \qquad ( 17 )$$
where a and b are predetermined weightings of F₁(u₀) and F₂(u₀)
in which the value of the function F(u*) and the value of its derivative or the value of the function F(u*, π) and the value of its derivative are used for the search for a solution u* to the optimization problem (17), said derivative value being determined by expressing said derivative on the basis of the estimation of said induced property R(u) in which the function S(xₖ, r) is approximated by the sigmoid function SC(xₖ, r) (8) such as defined according to claim 2, said value of the function F(u*) or F(u*, π) being determined on the basis of said estimation of said induced property R(u) in which the function S(xₖ, r) is optionally approximated by the sigmoid function SC(xₖ, r) (8) such as defined according to claim 2,
if F(u*, π)=0, the recipe u* is applied, otherwise a point u₁ is found in]u₀, u*] such that F (u₁, π)=0 and u₁ is applied.

11. The monitoring method as claimed in one of claim 9, in which, in the course of step (b), if Rⱼ(uₘₐₓ)≦R̅ⱼ̅, then π̅_{R}_{ⱼ}=0, with uₘₐₓ←argmax Rⱼ(u), u satisfying the set of constraints (16) and/or if Rⱼ(uₘₐₓ)≦R̅ⱼ̅π_{R}_{ⱼ}=0, with uₘᵢₙ←argmin Rⱼ(u), u satisfying the set of constraints (16′).

12. The monitoring method as claimed in claim 1, in which:
the mixture M is a mixture of hydrocarbons,
the properties x of said mixture are chosen at least from among the oxygen content, the sulfur content, the vapor pressure, the distillation fraction at 200° F., the distillation fraction at 300° F., the aromatics content, the benzene content, the olefins content, the methyl ethylbenzene content, the ethyl terbutyl ether content, the tertioamylathylether content,
the induced properties Rj of the mixture are chosen from among the emissions (V) of volatile organic compounds, the emissions (V) of nitrogen oxides and the emissions (7) of toxic compounds.

13. A computer program product comprising instructions for performing the steps of the method as claimed in claim 1, when these instructions are executed by a processor.

14. A system for monitoring properties of a mixture M of n constituents, said system being linked to means for distributing constituents to a unit for mixing constituents, comprising:
means (111) for determining the properties x(B, u) of said mixture, where:
x(u)=[x₁, . . . xₖ] is a vector of k properties of the mixture M, k a positive non-zero integer,
u=[u₁, . . . u₂] is a recipe vector and uᵢ, i=1, . . . , n, indicates the proportion of the ith constituent in the mixture M,
B=[B₁, . . . , Bₙ] is a matrix of the characteristics of the n constituents,
a management system (112) comprising:
means (113) for receiving said properties x(B, u)
storage means (114) for storing the values of the properties provided by the receiving means, and at least one model for determining a mixture property R(u)=R(y(x(u)), z(x(u))) induced by the properties x(B, u), where
z(x(u))=y(x(u))−x(u)
y(x(u)) is a vector of properties of the mixture
and where y(x(u)) and z(x(u)) are such that they comply with disjunctive conditions which, for each property xₖ, allocate to yₖ at least one value chosen from among xₖ, mₖ, Mₖ, as a function of one or more inequalities between said value xₖ and at least one value mₖ, Mₖ, where mₖ, Mₖ are predefined constants and xₖ is the value of the property k for a recipe u,
processing means (115) designed:
to determine a recipe u of a mixture M so that the mixture complies with specifications Rⱼ, Rⱼ(u) and/or Rⱼ(u)≦R̅ⱼ for each property R₁, j=1, . . . , p (with p a positive non-zero integer), Rⱼ, R̅ⱼ̅ being admissible minimum and maximum values respectively of said induced property, by using an estimation of at least one property R(u) of a mixture M whose properties x(u) are provided by the determining means, said estimation using, for a set of determined properties of the mixture, a formulation of functions y(x(u)) and z(x(u)) so that, for each property xₖ considered, y(xₖ) and z(xₖ) are functions of S(xₖ, r), where:
$$\begin{matrix}S ( {x}_{k} , r ) = 0.5 \cdot ( 1 + sign ( {x}_{k} - r ) ) & ( 1 ) \\ sign ( {x}_{k} - r ) = \{ \begin{matrix}- 1 {x}_{k} \leq r \\ 1 {x}_{k} > r\end{matrix} , & ( 2 )\end{matrix}$$
r being equal to mₖ or Mₖ,
then generate at least one control signal for the distribution means as a function of the determined recipe u,
means (116) for transmitting the at least one control signal to the means for distributing the constituents.

15. The system for monitoring properties as claimed in claim 14, characterized in that the processing means are designed to implement an optimization step and/or steps (a) to (c) or (a) to (d) of the monitoring method as claimed in claim 8.

16. A unit (100) for mixing n constituents comprising means (110) for distributing n constituents into at least one mixture collector (108) and a monitoring system as claimed in claim 14.
